(19) United States
(12) Patent Application Publication
(10) Pub. No.: US 2006/0085255 A1
(43) Pub. Date: Apr. 20, 2006

(54) System, method and apparatus for modeling and utilizing metrics, processes and technology in marketing applications

(76) Inventors: Hunter Hastings, San Rafael, CA (US); C. Gordon Wade, Rosemary Beach, FL (US); Satprit S. Duggal, San Carlos, CA (US)

Correspondence Address: CHOATE, HALL & STEWART LLP, TWO INTERNATIONAL PLACE, BOSTON, MA, 02110, US

(21) Appl. No.: 11/235,386

(22) Filed: Sep. 26, 2005

Related U.S. Application Data
(60) Provisional application No. 60/613,446, filed on Sep. 27, 2004.
(60) Provisional application No. 60/613,424, filed on Sep. 27, 2004.

(51) Int. Cl. G06Q 30/00

(52) U.S. Cl. 705/14

(57) ABSTRACT

A system, method and apparatus for modeling and utilizing metrics, processes and technology in marketing applications. According to multiple embodiments, the present invention includes marketing models, processes, metrics and software implementations and the integration thereof in marketing management tools for analysis of marketing functions and methodology. In one aspect the present invention provides for the strategic creation, nurturing and enhancement of brand equity as a metric of the marketing process.

### CROSS-REFERENCE TO RELATED APPLICATIONS

The present application claims priority to U.S. Provisional App. No. 60/613,446, filed Sep. 27, 2004, entitled “System, Method and Apparatus for Modeling and Utilizing Metrics, Processes and Technology in Marketing Applications” and U.S. Provisional App. No. 60/613,424, filed September 27, 2004, entitled “Method and Apparatus for Building Brand Equity,” both of which are incorporated herein by reference.

### FIELD OF THE INVENTION

The present invention is directed to the field of marketing functions and methodology and more particularly to marketing models, processes, metrics and software implementations and the integration thereof in marketing management tools.

### BACKGROUND OF THE INVENTION

Marketing plays a central role in the financial performances and global competitiveness of most major corporations. However, marketing processes and their results have typically been considered difficult to measure and, in general, there has been relatively little use of technology in marketing functions that would allow for the assessment and proliferation of “best marketing practices” within and between corporations. Without the standardization of marketing metrics and the ability to foster technical innovation in marketing, old-world marketing practices are lacking the kinds of creative developments that have been seen across other sectors of corporate management.

Marketing in many organizations is the key driver of top-line growth and a significant contributor to margin improvement. Marketing is also one of the most strategic activities as it is concerned with building brands—powerful assets capable of guaranteeing decades of sustained cash flow and a true source of competitive advantage. Recent studies from leading analyst firms have shown that there is a direct link between brand strength and the market valuation of the corporation.

Unfortunately, corporations do not, typically, have a shared knowledge base for marketing—for know-how, processes, data, success models or best practices. Consequently, marketing is conducted as an unscientific, ad hoc activity, lacking the science and objectivity of a true business discipline. The lack of shared knowledge across the corporation results in inefficient marketing efforts. This results in slow project completion and time to market, since there is debate about what is the best marketing process. Too often, the corporation has not codified and standardized its marketing processes resulting in misaligments and inconsistencies. There is a lack of defined processes and best practices. Other drawbacks include the re-invention of fire, the repetition of mistakes and the loss of corporate knowledge of works and what does not.

Marketing data and success models are rarely shared across SBUs and geographies, resulting in duplication of effort and the constant re-invention of fire in many parts of the organization. Moreover, the results of marketing programs are rarely measured and there are no mechanisms for building a corporate memory of what works and does not. This leads to costly mistakes being often repeated. Additionally, project coordination leaves no time for creativity since Brand Managers spend an inordinate amount of their time and efforts in attending a seemingly endless series of status meetings in an effort to manage their projects. This crowds out any time for strategic thought on the brand. Lack of data and analytical capability also reduces efficiency. Making marketing decisions requires integration of data from internal systems and external sources and the ability to analyze the data using sometimes highly sophisticated statistical techniques. This infrastructure does not exist today.

Accordingly, there is a need for a system, method and apparatus to help facilitate the function of marketing as an innovative engine for creating value and building brand building.

### SUMMARY OF THE INVENTION

The present invention provides a system, method and apparatus for modeling and utilizing metrics, processes and technology in marketing applications. According to multiple embodiments, the present invention includes marketing models, processes, metrics and software implementations and the integration thereof in marketing management tools for analysis of marketing functions and methodology. In particular, the present invention provides for the strategic creation, nurturing and enhancement of brand equity as a metric of the marketing process.

In one aspect, the present invention provides improved methods and apparatus for creating uniform marketing practices and improving system efficiency by providing systems that distribute marketing information across the company, including a marketing knowledge center. In another aspect, the present invention facilitates identification of brand imperatives and initiatives through objective setting and what-if scenario planning. In another aspect, the present invention helps allocate marketing investments against the right target audience segments using the marketing tools and tactics including domain strategy and brand equity processes. The target audience segments may be behaviorally defined and may further characterized by utilizing additional knowledge of the segments' demographics, psychographics and attitudes, brand equity ratings, shopping and media consumption habits, and geographical location. In other aspects, the present invention helps make allocation decisions across marketing mix elements for enhanced marketing ROI, tracks the brand's performance along the defined objectives, and establishes the link between brand equity and behavioral loyalty.

In other aspects, the inventions provides for creating a loyalty ladder; performing scenario analysis; setting at least one imperative and at least one initiative; and tracking performance of the imperative and initiative. In some embodiments, the method may include determining the ladder output and providing data for the loyalty ladder. The performing steps may comprise creating scenarios, viewing scenario impact, and saving scenarios. In some embodiments, the setting step may comprise: setting LEAP targets, identifying imperatives, setting STEP targets, and identifying initiatives. The present method, its software implementation, and related tools are themselves are not limited to any computer system, network, or configuration but instead can be adopted by a user in ways that are deemed most appropriate by those users.

### BRIEF DESCRIPTION OF THE DRAWING

The invention is described with reference to the several figures of the drawing, in which:

FIG. 1 is a schematic illustration of a marketing framework for building brand equity according to one embodiment of the invention;

FIG. 2 is a schematic illustration of the integration of an end-to-end architecture in a marketing solution stack according to one embodiment of the invention;

FIG. 3A is a schematic illustration of an interface for delivering the marketing process and best practices content of to a user according to one embodiment of the invention;

FIG. 3B is a schematic illustration of an analytical tool for metrics tracking and analysis to support the marketing processes according to one embodiment of the invention;

FIG. 4 is a schematic illustration of a hierarchy of needs according to one embodiment of the invention;

FIG. 5 is an illustration of a conceptual domain map according to one embodiment of the invention;

FIG. 6 illustrates the process and metrics that can measure the power of brand commitment according to one embodiment of the invention;

FIG. 7 illustrates a brand equity framework process according to one embodiment of the invention;

FIG. 8 illustrates the LEAP process according to one embodiment of the invention;

FIG. 9 illustrates the three phases of the LEAP process according to one embodiment of the invention;

FIGS. 10A and B illustrate examples of the goal-setting template for brand equity and penetration and loyalty metrics, showing a brand long-term equity appreciation plan, a loyalty ladder profile, and a brand equity scorecard according to one embodiment of the invention;

FIGS. 11A and B illustrates a template for a long-term equity acquisition plan according to one embodiment of the invention;

FIG. 12 illustrates a brand equity monitor framework according to one embodiment of the invention;

FIG. 13 illustrates a brand commitment profile according to one embodiment of the invention;

FIG. 14A, B and C illustrates a brand equity monitor and interface guide according to one embodiment of the invention;

FIG. 15 is a marketing process tasks chart according to one embodiment of the invention; and

FIGS. 16A and B are schematic illustrations of marketing knowledge center interfaces according to various embodiments of the invention.

### DETAILED DESCRIPTION OF VARIOUS EMBODIMENTS OF THE INVENTION

The present invention provides a system, method and apparatus for modeling and utilizing metrics, processes and technology in marketing applications. According to multiple embodiments, the present invention includes marketing models, processes, metrics and software implementations and the integration thereof in marketing management tools for analysis of marketing functions and methodology. In particular, the present invention provides for the creation, nurturing and enhancement of brand equity as a metric of the marketing process.

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. References cited herein are hereby incorporated by reference in their entirety, except to the extent that they conflict with teachings explicitly set forth in this specification.

The following are known systems and processes related to marketing functions:

U.S. Patent Application Publication No. US 2002/0099679 to Usitalo et al., which is incorporated herein by reference, discloses a virtual interactive expert solution system for providing networked based solutions and expertise to users in a marketing knowledge area.

U.S. Patent Application Publication No. US 2003/0033192 to Zyman et al., which is incorporated herein by reference, discloses strategic marketing planning processes, marketing effectiveness tools and systems, and marketing investment manager for performing situation assessment, identifying opportunities, developing growth strategies, developing growth tactics, and developing measurements.

Referring now to the figures of the drawing, the figures constitute a part of this specification and illustrate exemplary embodiments of the invention. It is to be understood that in some instances various aspects of the invention may be shown schematically or may be exaggerated to facilitate an understanding of the invention.

Marketing Framework

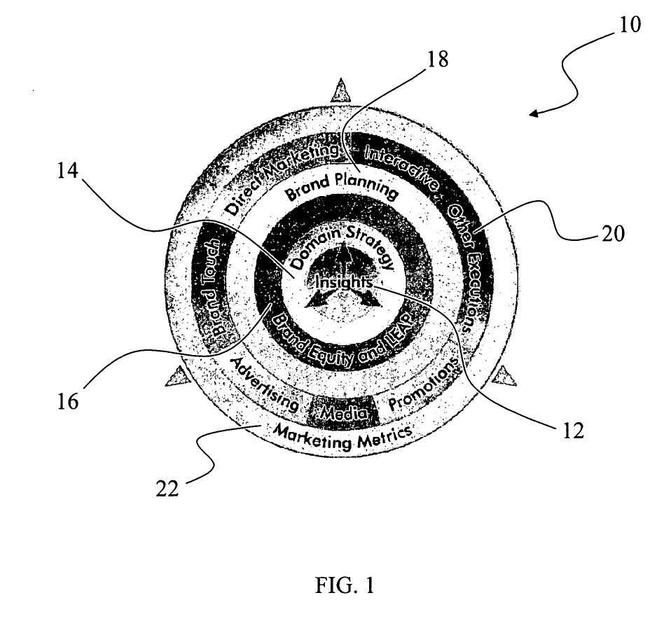

FIG. 1 is a schematic illustration of a marketing framework 10 for building brand equity according to one embodiment of the invention. Brand building begins with insights as the foundation, works through long-term brand strategy, creates and executes the short-term plan, and is followed by best practice analytics that will drive the next cycle starting at insights—a closed-loop solution that drives long-term brand growth.

The components of the marketing framework 10 are identified as follows:
(1) Insights 12: This is a process for systematizing the conversion of the myriad of facts and observations into insights, the profound understanding that leads to a business idea that drives profitable growth. Insights are the lifeblood of a successful marketing program and drive the strategy, planning, and marketing execution of the brand.
(2) Domain strategy 14: This is a process to identify the domain: the linked set of customer needs within which the brand exists (e.g., oral care rather than toothbrushes and business solutions rather than computers). It also contains tools to identify the spaces within the domain where the brand can and cannot expand.
(3) Brand equity and LEAP 16: This sets the long-term vision for the brand, identifies where its equity is placed currently, and identifies the challenge facing the brand. Brand equity is defined and measured and a long-term equity appreciation plan (LEAP) is created for the development of the brand's equity.
(4) Brand planning 18: This is the development of the brand's plan and budgets to meet its immediate financial targets as well as the long-term equity goals. It is a highly collaborative process involving various marketing functions and groups to create an integrated marketing strategy that delivers a 360-degree approach to the consumer/customer.
(5) Brand activation 20: This comprises the marketing mix that connects the brand to the customer. It includes product development, advertising, media planning and buying, promotion, direct marketing, interactive, brand touch, PR, and other such processes.
(6) Marketing metrics 22: The marketing mix vehicles are supported by a comprehensive metrics structure that links a brand's financial outcomes to the strength of its brand equity. This, in turn, is linked to each of the executional drivers such as communications and innovation.

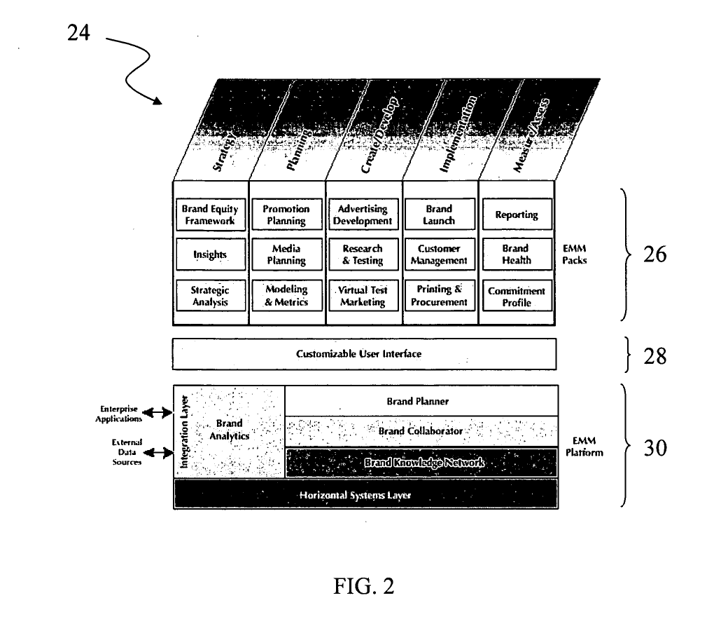

FIG. 2 is a schematic illustration of the integration of an end-to-end architecture in a marketing solution stack 24 according to one embodiment of the invention. The marketing solution stack includes software components (EMM packs) to perform various functions including collaboration software that enables collaboration among marketing project teams and planning software that allows the common planning and tracking of all marketing elements such as media, promotion, direct mail campaigns and others in one place. The software components may provide for a digital asset and document repository that serves as the marketing knowledge center 26. A user may access the software packs and marketing knowledge center 26 via a customizable user interface 28. An analytical engine 30 provides a platform (EMM platform) for integration of internal and external data and makes the data available for metrics tracking and analysis to support the marketing processes and which enables scenario planning All of these components are further described in detail elsewhere herein.

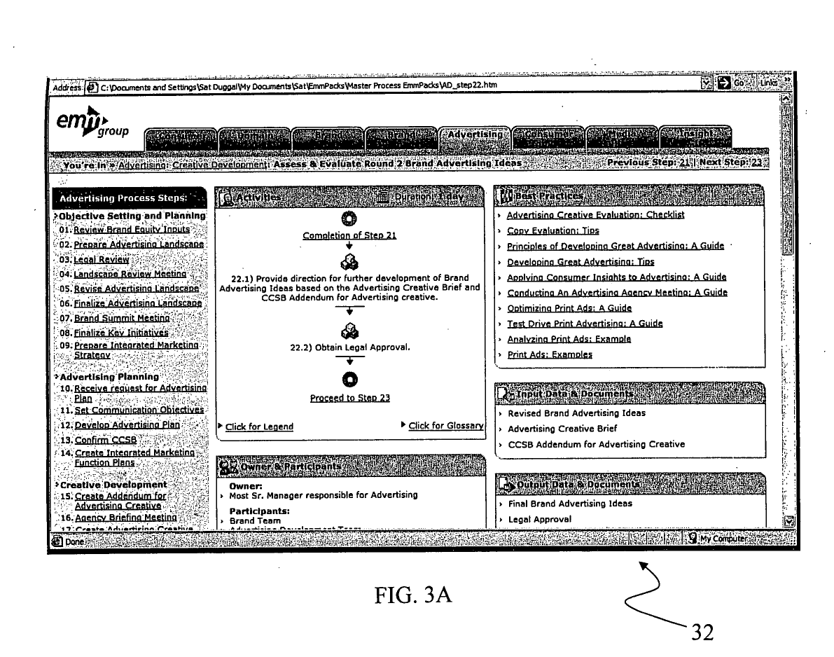

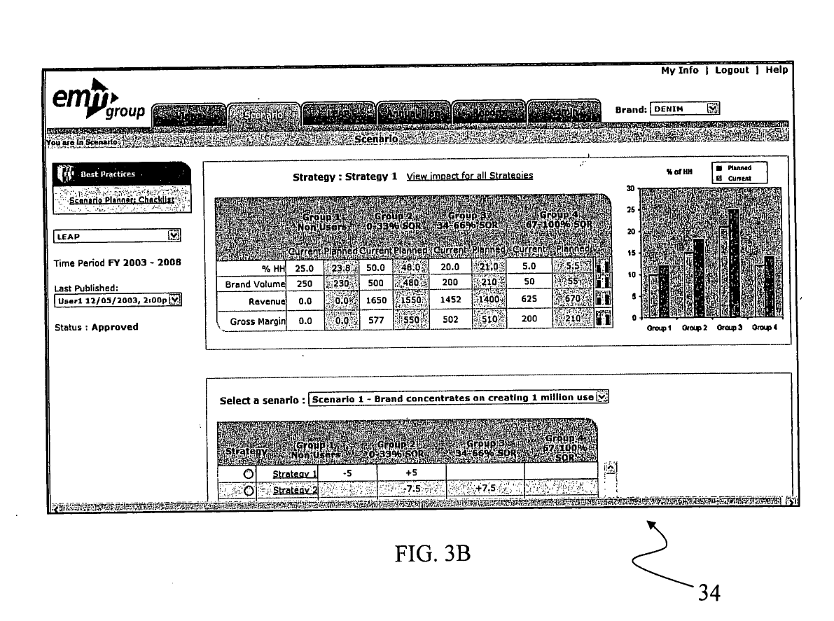

FIG. 3A is a sample screen shot of an implementation 32 of an analytical engine and user interface for delivering the marketing process and best practices content of to, a user. FIG. 3B is a schematic illustration of an analytical tool 34 for metrics tracking and analysis to support the marketing processes according to one embodiment of the invention.

The components of the marketing framework will now be described in detail:

Insights

An insight as a profound understanding of the customer and customer needs that leads to a business idea that drives profitable growth. The central insight provides the light that allows the marketer to see into the customer's heart. The same insight illuminates every step on the pathway to building a stronger brand. Marketers' belief in the centrality of insights was not always so intense or widespread. One of the great changes in brand building and business building today is the importance placed on harnessing the power of insights across the entire business value chain.

What is most useful in our approach to insight development is that we do not believe it to be the exclusive province of the intuitive genius or even the market research department. Rather, we believe insight development is a requirement of every professional in the organization and that it is an inherent capability of everyone in the organization. Every marketing leader can turn his or her organization—indeed the entire enterprise—into an insights machine with the right process, the right tools, and the right training. In the same way that marketing and brand building are processes, insights can be generated by a process. Systematized insights generation can become a sustainable competitive advantage.

In various embodiments, the present invention is based on the belief that every brand wins the affective commitment and practical purchase loyalty of the customer by developing the insights that allow the brand to own the “moment of truth.” For most brands there are actually three moments of truth. First is when the product is in use and the combination of “brand touches” during that usage experience reinforces the customer's loyalty to the brand. No matter what your product or service, no matter whether your buyer is a 12-year-old girl using her first lip gloss or a hard-nosed corporate purchasing manager evaluating building and grounds maintenance, you must deliver during the moment of truth as defined by that buyer.

A second critical moment of truth occurs before the “moment of truth” represented by the usage experience. It's the few seconds or few minutes just before the purchase when the buyer is considering an array of choices. In the consumer products industry, it's the moment of truth in the aisle at the shelf where the customer passes judgment on the array of benefits, both real and emotional, you are offering him/her. For virtually all consumer package goods brands, this has been the most neglected of the moments of truth. Now major marketers are spending millions to capture that moment of truth. Some are delving deeply into exotic fields like “semiotics,” the study of symbols and memory, to link the physical package to the range of emotions that trigger a favorable purchase decision.

A third and in some ways the most elusive of the moments of truth is that one that forms the core of your brand promise.

Insight development is about the range of moments of truth from the essential insight that drives affective commitment to the in-store purchase decision to the in-use experience. In one embodiment, the present invention provides a process and a best practice organizational construct enabled with tools to turn a company into an insights-hungry, insights discovery machine.

In our experience all companies have a wealth of knowledge about their business, their customers, and their competitors. Unfortunately, most companies do not know what they know. Their knowledge is scattered about the corporation, much of it secreted away in the fragile memories of current and former employees. Many companies have created whole departments run by specialists in knowledge management to address the challenge of knowing what they know.

The biggest challenges faced by these knowledge management professionals is not managing the “knowledge” that exists or even finding lost data, but gaining agreement on what is truly knowledge and what is merely random data that is actually irrelevant, misleading, or worse still, wrong. Accordingly, in one embodiment, the present invention provides for the creation of a specific repository of brand wisdom. A logical taxonomy of what a company knows about the customers of the brand and the markets in which the brand competes. This taxonomy is termed “The Voice of the Customer.” The Voice of the Customer (VOC) includes: hierarchy of needs; functional benefits; values related to usage; customer usage behavior; purchase/shopping habits; media usage behavior; customer hopes/fears; customer solution; and competitive issues.

VOC arrays the company's knowledge of its customers in a logical manner. It encompasses the entire experience of the brand from a list of current insights about the customers' experience with the brand down through actual usage occasions, demographics, media consumption, buying habits, and so on.

One of the components of the Voice of the Customer is the so-called “Customer Solution.” What are customers doing today to create a benefit that they cannot obtain from using current products or services in the category? A classic customer solution was consumers' use of baking powder as a dentifrice to produce a better end result (fresher mouth feel and whiter teeth).

Building the VOC is a collegial task requiring the active participation of experienced representatives from many company functions. The purpose of the initial VOC creation is to achieve three things: (1) Agree on what is true, reliable, actionable data: the “basic truths” of the business; (2) Agree on what needs to be explored because it is poorly understood; and (3) Agree on what is totally unknown and needs to be addressed rapidly. From this initial VOC creation, the business team can begin developing its “learning plan.” Learning is one of the three basic obligations of the marketer (the other two being “making the numbers”—succeeding at meeting revenue and margin targets—and building brand equity).

But merely assembling what you know and building a learning plan is not enough. One must be able to build insight creation into the very “DNA” of the company. One must create a process, an organization, and tools to keep the insights coming. Two factors that will make insight discovery a challenge. One is the pride of the internal professionals in your market research function. Many market research departments are notorious for believing that they “own” the insights process, because they understand everything about their customers and product category. They are unprepared emotionally to admit any ignorance because, in effect, doing so indicates that they have failed in their responsibilities to the company. The second challenge is even more daunting: How do you know what you don't know? The combination of market research hubris and not knowing what you don't know can erect an insurmountable barrier to your insights creation process.

These challenges can be overcome. A process can be created to have every function identify its unknowns. The key to this process is something we call IWIKs (“I wish I knews”) and, according to one embodiment of the invention, these are included in the best practice brand-building process through something called “landscapes.” The IWIKs play an important role in the process we have devised to identify insights and drive innovation.

In the brand-building process, one should ask every functional area in the company to look for IWIKs from its unique perspective. Specifically, one should ask for IWIKs as part of the process step of creating what we call landscapes. Every function in the company, on an annual basis, produces a landscape that outlines what is going on in their specific area of activity, whether that be R&D, media, market research, competitive analysis, packaging, store operations, sales, finance, logistics, or advertising. Each landscape template requires that the function formally identify IWIKs.

Our process also encourages anyone in the organization at any time to report any fact, occurrence, or observation that seems to suggest an issue worth further investigation or, in other words, is an IWIK. The overall process is geared to address both the regular annually produced IWIKs and the spontaneous IWIKs that sprout from anywhere. Under ideal circumstances, an organization will produce lots of IWIKs and will have in place the process and the people to winnow out the irrelevant issues and focus on those few insights that can produce advantage.

The insights process should be driven by an organization that recognizes two critical truths: (1) while anyone can produce an IWIK, some people are far better at identifying insights than others; (2) those closest to an individual discipline are generally the best at sorting the wheat from the chaff. Therefore, our process in effect funnels all of the IWIKs through those individuals (“insights managers”). Their immediate task is simple: compare the IWIK to the Voice of the Customer. If that step suggests further review, the insights manager exposes the issue to those people in the organization who have specialized knowledge of the issue in question.

By this simple process, the internal insights manager can rapidly winnow out those issues (IWIKs) of little merit and focus on those that the best minds in the company believe can be developed into a profound understanding. Their job is to sift the good ideas from the bad and to make good ideas so much better that they readily secure funding from senior management.

The process exposes IWIKs to every key function, and thereby enrolls as supporters the very people with the best judgment and most incentive to turn ideas into innovation. The process asks each relevant function to pass the IWIK through a series of screens that can generate metrics for comparing the value of an insight: Brand equity alignment or synergy; Margin implication; Speed to market; Effect on volume; and Cost/ROI.

Once an IWIK-inspired idea passes an initial screening process, it is re-examined against all items in the portfolio to begin the process of prioritizing its importance in the pipeline. These metrics include:

Brand equity alignment or synergy: An idea that does not support or is not consistent with the basic equity of the brand is going to get discarded or passed to a different brand or perhaps to a separate new product process. The fact is that many ideas are brand or domain neutral; there are “good ideas” that can be used by many brands without affecting equity issues. But the very best ideas enhance brand equity—such as a running shoe tread design that allows runners to believe they can run faster when they wear the shoes.

Margin implication: Some IWIKs lead to great insights but productizing the insight costs so much that the product's profit margin would be impaired or its price forced to levels beyond consumer acceptability. In such cases, the process will either discard the idea altogether or recycle it into R&D for the purpose of exploring ways to reduce costs. Plasma screens are a good idea based on the insight that customers will invest in enhancing their home entertainment experience, but their rapid penetration depends on meeting customers' price point expectations.

Speed to market: Studies suggest that the first mover on an idea or technology seizes a disproportionate percentage of available profits. Yet, many companies dawdle over ideas and delay commercialization unconscionably. The purpose of this screen is to identify whether this idea can be commercialized rapidly. This can become an important factor in assessing its competitive value within the brand's overall innovation program.

Effect on volume: Initially, this is a ballpark number aimed at placing the insight or innovation into perspective. At a second screening stage, companies apply other methods to calibrate the volume from the idea, but initially they need use only experience and “success models” from similar innovations.

Cost/ROI: A surprising number of insights can be brought to market as innovations without capital investment or with funds that qualify as an ongoing cost of doing business. One good example is innovation in advertising copy brought to the public with funds set aside for new commercial production that year. But many innovations do require capital or do incur an ongoing expense. Most companies have adequate evaluation approaches. What they don't have is enough ideas to turn into innovation.

Some insights are so profound, so high on the means-end chain that they can extend their influence to an entire consumer domain. These high-level customer insights, because they tend to focus on customers' emotions and needs that are high on the pyramid of affective values, unlock customer permission for the brand to move into areas where it has little or no technological superiority. What the brand does have in these situations is emotional superiority, and the trust of their customers.

We referred above to the spontaneous developments or discoveries that cause someone in the company to send an IWIK to the insight manager. The insight manager has some tools to evaluate this IWIK, including:

The Competitive Scenario Tool: In this case, the Insight Manger (IM) creates two teams representing the company and its major competitor. The IM asks the teams to develop a scenario about how each would respond to the new IWIK (it could be a new patent, a new media opportunity, a new packaging material, some new software, etc.). The teams then use their experience with their own company or the competitor to evaluate the importance of the IWIK, how both companies might use it, and the implications for each company's business. The scenario approach was originally developed by Shell Oil in the 1980s and has received significant publicity in major business strategy journals. In our experience, the approach works well in creating and evaluating insights.

The Cross-Trend Analysis: This approach is especially useful when you are seeking insights about opportunities, in other words when you are actively seeking to create an IWIK for evaluation. The essence of this approach is looking for mutually reinforcing synergistic trends that will drive a major business idea. An example will clarify the approach: A major trend recognized by everyone is aging and the need to care for the exploding group called the “old old” (those over 85). A related trend is the geographic dispersal of families such that the younger generation is not physically proximate to provide personal care. A third trend is the dramatic growth in wealthy elderly people who have the financial wherewithal and the desire to provide for their own care. Put these three trends together and one can recognize a huge potential for prepaid “nursing home insurance” sold to the wealthy elderly.

The Looking Backward Story: This approach begins with an IWIK identifying some new development (e.g., a new demographic trend, a new legal or regulatory development, a competitive patent announcement). The IM asks one of the experts in the company to write a story about this development from the perspective of five years hence—“looking backward” at the effect it has had on customers, competitors, and the company. That “looking backward” story then is circulated to interested parties within the company to solicit their insights or recommendations on how the company should respond today.

In summary, insight process provides an enhanced process for brand building and includes such foundational tools as the Voice of the Customer wherein the company archives the accepted truths across a range of behaviors and attitudes relevant to the customer. Once the date from the VOC is collected, the various embodiments of the present invention provide for a process in which the VOC and insights are enriched by data flowing into the VOC from various artifacts of the entire process (i.e. landscape reports, etc. . . ). Further, the concept of “I wish I know” (IWIK's) enable the company to identify what the do not know. Finally the insights process offers a methodology for building a learning plan which accomodates the IWIK's as well as the long term brand equity building needs of the enterprise. The process is enabled by content which allows the user to query each step and receive guides, examples and checklists pertinent to the process.

Domain Strategy

The purpose of marketing is to generate growth. The vehicle to do so is the brand. Some skeptics say that the days of brands are over. Perceptive observers, on the other hand, see a number of major branded businesses achieving high growth rates, even from brands that are old and may at one time have been flat or dormant.

In one embodiment, the prevent invention includes a strategy tool called the Domain Strategy process. This is the strategy to generate growth by making a brand more relevant to more people in more parts of their lives. It is the most powerful growth weapon in the business arsenal. The new brand-led growth solution requires new thinking by the brand owners themselves because their customers (we'll use that word to signify the consumers targeted by B2C brands and the customers targeted by B2B brands) have been looking at things in a different way from brand owners for a long time. Brand owners have to break out of their self-imposed limitations to catch up with customers. We offer domain strategy as the process for doing just that.

Customers seldom think in terms of product or service categories. They think in terms of their needs. As customers or business people or end users, their lives are an amalgam of needs to be met and solutions to meet them. The customer of a cosmetics brand isn't consuming in the cosmetics category, she is meeting a need for confidence and self-esteem based on the way she feels about her appearance and how others perceive her. The business customers of a computer technology brand are not consuming in that category, they are meeting a need to feel confident about their efficient and competitive business performance. The consumers of health care products are meeting a need to feel reassured that they are addressing and managing their condition in an optimal way. Customers think not only in terms of functional needs, but specifically in terms of emotional needs. They want to feel confident, self-actualized, a sense of achievement, and to live a life of harmony that's secure, happy, and fulfilled. Thus marketing works best when it appeals to values at the pinnacle of the “pyramid of life.” Successfully doing so leads to higher financial returns for the firm.

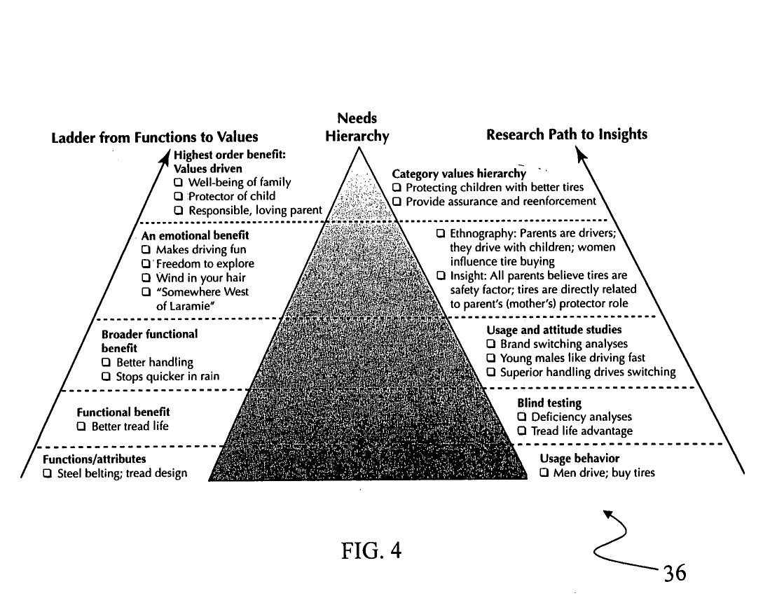

An easy way to visualize the customer needs is to think of them in pyramid form with an ascending hierarchy of importance from lowest to highest. FIG. 4 is a schematic illustration of a hierarchy of needs pyramid 36 for an example of a brand of tires. The base level is functional. The tires must work to support another activity, driving. Over time, the functionality can be raised, so that tread life is extended and performance is improved. However, the customer engagement is still in the area of functional needs. As customer knowledge and insights improve, a certain amount of refinement enters into customer understanding. Behavioral and demographic segments emerge, such as younger drivers, fast drivers, and drivers who treat their car as an object of pride and self-expression.

At the base of the pyramid are the “price of entry” needs. These represent the minimum the customer expects from any product or service in a category where her or she is considering a purchase. These needs are functional—customers want the product or service to work, to do what it says it does.

Ascending the hierarchy, the customer will have some functional needs that, once the price of entry needs are met, represent a higher level of potential satisfaction, to be met by superior performance over and above basic functionality. The needs are still functional, but somewhat refined.

Ascending the hierarchy still further, the customer will have some emotional needs that are of a higher order entirely from functional needs. The same escalation to emotional benefits applies to customers selecting business products and solutions—they're looking for a sense of achievement, pride, and accomplishment in their selection, and its effect on business results.

At the very top of the hierarchy is the highest-level need that you can strive to fulfill for a customer. In the academic literature, these are called “terminal” values, and they include needs such as family security, social recognition, and freedom. They are needs beyond which there is no further upward escalation. It's not always possible to attain these high values in marketing a product or service, but the great brands aim as high as they can possibly reach.

Deeper digging using techniques such as ethnography (where researchers accompany customers to observe them in their daily lives) reveals new insights. Drivers are not just drivers, but parents; they care for their children and hope to keep them safe at all times. Tires are in the domain of expressing love via family safety and protection. At this stage we are approaching the apex of the insights process and the brand equity pyramid. We have identified what the sociologists call a “terminal value”—i.e., you can go no higher than family love, safety, and protection on the scale of human values. Now the task is to capture that via brand promise and brand touch (the purchase, usage, and ownership experience).

This same hierarchy applies just as well to B2B brands. Buyers and decision makers are not just functional role players; they are human agents with values and emotions. They work for a sense of accomplishment, to achieve great things, to feel a sense of pride and worth, as well as to contribute to the realization of their company's inspiring mission statement. These and many other emotional values are integrated into their decision making and their relationship with your brand of technology or office supplies or financial services. The hierarchy of needs is equally as applicable as an insights device in B2B and B2C.

The types of needs customers feel are not bound by any construct as limiting as product or service categories. If customers seek fulfillment in the cleanliness, hygiene, orderliness, and attractiveness of their bathroom, they are not thinking about the toilet tissue category and the facial tissue category and the towel category and the soap category and the bathroom appliance category and the bathroom furniture category and the bathroom fixture category. They are thinking about the feeling they have when they enter their bathroom—about its compliance with their core values, about its reflection on them, about how it looks to guests, and about the total bathroom experience. The same is true of customers of baby care, business services, transportation, health care, and telecommunications. Customers link a broad set of needs together into a solution set that addresses their highest-level needs. Needs are linked across these solution spaces; they are not discrete.

If you define your brands in a fashion that's bounded by category limits, then you are not in tune with your customers, and you are missing significant potential for growth. Customers link a set of needs in their mind, and have demonstrated willingness to buy a single brand to meet all these linked needs. That's why a company can successfully sell soap, skin cleansers, deodorant, shampoo, moisturizing cream, and toner to women who feel that the health of their skin is important to their feelings of self-esteem.

Many factors play into a brand's ability to cross a broad domain of customer needs. The reality is that it is the brands that have built the strongest credibility, making the most of their strategic drivers, that have been most successful with product and market extensions.

The challenge marketers face is in identifying the key dimensions of brand equity, profiling their brand against these dimensions, and then modeling core strategic brand drivers. But the profiling process must be moved beyond an expansive cataloguing of a brand's associations. The focus must shift to those that have real impact and then draw conclusions between strategic brand drivers and business outcomes. This enables both the tangible and the higher-order intangible associations with the brand to be better leveraged and managed.

For example, suppose an up-and-coming brand in a competitive segment in the soft drink industry spends millions each year in support of its brand. It recognizes the need to grow the business, but wants to make sure that the nature of the support it is giving the brand is measured and strategic so that the foundation for future growth would be solid rather than haphazardly built. It wants a better understanding of the consumer “levers” to pull.

A more in-depth brand equity profile and model would help this business better understand how the brand is perceived and what aspects of the brand were most compelling in encouraging customer loyalty and a willingness to pay more (i.e., allowing the brand to command price premiums).

The first step in the process is building the model around which the brand equity is based. Its foundation is the product or service, which is described for its attributes (not its or the brand's benefits), scope, uses, and where it is acquired, used, or seen. Building on that foundation are the four important dimensions of brand equity: (1) The brand reputation, the tangible and intangible perceptions of what it is “good at”; (2) The values and personality of the brand and its users, providing insight into the brand's “character”; (3) The multidimensional benefits delivered by the brand—functional, emotional, and self-expressive; and (4) The areas of brand leadership, along with perceptions of its momentum in the market and ability to persuade stakeholders that it is relevant Businesses that intend to reap the benefits of using brands as a driver of business success need to begin the process of identifying and managing, in a systematic and structured way, the associations that contribute to brand equity and that are critical to enhancing the brand's value and the extent to which it financially impacts on the business. This activity is domain strategy.

Like everything else in marketing, domain strategy is a process. It is a process can be applied to a brand or business and includes the following components:

Listen to the Customer:

An important aspect of domain strategy is the understanding that the customer defines the domain. This is key to the breakout strategy. We simply need to listen to the customers describe their needs and all the needs that are linked together in a single need space, in order to begin to define a domain in which our brand or business can grow. There are some structured research techniques available to do this, but the fundamental principle is to let the customer, not the brand, define the domain.

Find the Highest-Level, Overarching Need:

The needs in the domain are linked because they all contribute to a single, overarching need that the customer is pursuing. The theory behind this idea is an analysis of customer behavior called a “means-end chain.” All customers have certain values by which they live their lives. Their “end” is to achieve these values. Values include states such as “a comfortable life,” “inner harmony,” “self-esteem,” and “safety and security.” When choosing products, customers identify and select those products whose “means” result in “consequences” that contribute toward the consumers achieving their end of attaining a particular value that's important to them.

Identify the Subsidiary Need Spaces in the Domain:

Once the high-level need is identified, and the broad outlines of the domain are in sight, the brand owner can seek to identify all the subsidiary need spaces in the domain. The subsidiary need spaces are dynamic, and can change over time, even though the overarching need does not change.

Draw a Domain Map and Size up the Business Opportunity:

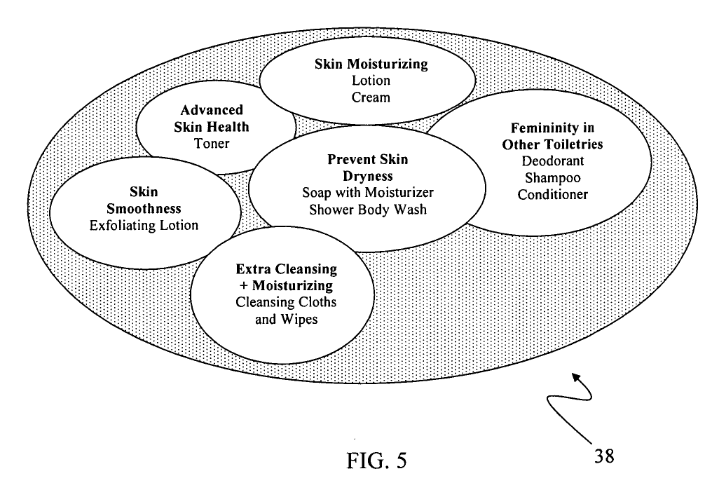

It is useful to capture the domain strategy concept in a graphic called a domain map. An example of a conceptual domain map 38 is illustrated in FIG. 5 with respect to a domain of “restoring femininity.” In this conceptual map, the need spaces are identified as skin moisturizing, advanced skin health, skin smoothness, and so on. These are not product categories; they are consumer needs. As the process advances, the total domain size can be identified, the total growth rate (made up of the weighted average growth rates of each of the spaces) can be estimated, and the business potential of the domain can be sized up. This is achieved by identifying how much customers spend on solutions in each space. The sum and the trend can be quickly ascertained from primary and secondary data sources. The domain map becomes an expression of the business potential for the brand to grow.

Formalize the Growth Strategy:

The final step at this stage is to formalize the growth strategy. The opportunities within the domain can be evaluated using scorecard techniques. Scorecard metrics include opportunity rankings (the size and growth rate of the spaces, the opportunity for margin, the degree of contest anticipated, the quality of the brand fit) and cost of seizing the opportunities (such as investment costs, costs of entry, and degree of difficulty in identifying new advantaged solutions).

Having scorecarded the opportunity, it's time to go to the board or the executive committee with the recommendation to grow the brand in the domain. The opportunity should be dramatic in terms of new spaces to enter, new growth rates, and new global expansion routes. With this new playing field the brand can identify new pathways to growth. When done successfully, such brand expansions can have several advantages: (1) Distributors may perceive there is less risk with a new product if it carries a familiar brand name; (2) Customers will associate the quality of the established brand name with the new product and will be more likely to trust the new product; (3) The new product will attract quicker customer awareness, along with a willingness to try or sample the product; and (4) Promotional launch costs (particularly advertising) are likely to be substantially lower.

Marketing has transitioned from being product-centric to being brand-centric. This enables the brand management group to break out of low-growth or mature product categories. The domain strategy model provides a process for any brand to map its opportunities and by listening to the consumer, to find new innovative products and even create new categories that will be accepted by a loyal consumer base.

Building Brand Equity

We have discussed the insights process on which to base a differentiated delivery of solutions to customer needs, and we have defined and sized a domain where sustainable high levels of growth can be engineered. The next step is to create the brand equity framework with a brand vision, brand challenge, and a long-term equity appreciation plan (LEAP).

Building brand equity is a difficult task but it's not the arbitrary, ad hoc, mysterious black magic that creative marketing geniuses want us to believe that only they can master. With discipline, care, knowledge, and, most important, process, brand equity can be built systematically over time.

In order to make this complex process simpler, we've established three tools that guide the brand equity management process: (1) Brand vision is a composite document describing where the brand aspires to be, both as a business and in customers' perceptions, and the core assets it will employ to get there.; (2) Brand challenge is an honest appraisal of the barriers to overcome to get there.; (3) LEAP is the multi-year plan to achieve the vision and meet the challenge.

You can pose two simple questions to understand brand vision and brand challenge: (1) What is brand equity? and (2) How does it drive financial results? In the financial world the word “equity” is used to refer to financial instruments that represent an ownership interest in the financial outcomes of a company or investment. A representation of how a number of equities are performing as a group is often expressed as an index number—the Dow Jones Industrial Average, the S&P 500 Index, the Nasdaq 100, and so on. When that number goes up, the financial outcomes of the companies whose equities make up the index have improved.

Brand equity refers to that element of a brand's perception that directly determines the financial outcomes of brand ownership. When the brand equity index goes up, the financial outcomes of the brand (top-line revenue growth, gross margin, and brand value added) will go up. Brand equity can be described as the perceptions that consumers have of a brand at any point in time based on everything they have seen, heard, or experienced.

Many CFOs have an initial negative reaction to the idea that a perception—an intangible and primarily emotional feeling in a customer's mind—can determine a financial result. However, if you multiply feelings about a brand by millions of consumers, you can create financial outcomes. The reputation of a company is often based on emotional foundations such as trust and familiarity. During the recession of 2001-2003 we witnessed that when the company's reputation sinks—often as a result of emotional reactions-shareholder value is immediately damaged.

Consider the University of Michigan Consumer Confidence Index. It is derived entirely from an emotional reaction—the answer to this question: How do you feel about the economy and how it will perform in the future? It frequently varies as respondent confidence see-saws between optimism and pessimism. The researchers massage these emotional responses into an index number and publish it each month. If perceived consumer confidence goes up, the stock market usually reacts positively and shareholder value is created, and if consumer confidence declines, billions of dollars of shareholder value can be destroyed in seconds. So, we can easily see how emotions, perceptions, and opinions have an immediate effect on value creation and financial outcomes.

Outside observers often make the mistake of equating marketing and the brand- building process exclusively with communications, and specifically advertising. They think that marketing is the end of the value chain, the last “coat of polish” to a business proposition that is already formed. But if we define brand perception as everything customers see, hear, and experience, we quickly realize that marketing encompasses the company's entire business proposition. In the best brand-building companies, “everyone does marketing.” Anything and anyone who touches the customer is marketing to that customer. Hence the growing attention to the concept of a brand's “touch points.” The customer's experiences include the quality of the product or service, the efficiency of delivery and the supply chain behind it, and the responsiveness of the sales representative and the call-center operator. Customers do not depend solely on advertising to experience the brand. They can tell if the company listens to its customers or not. They see the company's trucks on the road, the decor of its offices and branches, the messages and visuals on point-of-sale material, and the content of direct mail and email messages, just as much as they see advertising or packaging.

Brand equity is a perception that can translate into commitment to a brand. There are two kinds of commitment: attitudinal and behavioral. Attitudinal commitment is a feeling about a brand that can be thought of as a continuum. One well-known version of this continuum uses a “4 A's” mnemonic:

Unaware. I have no feelings about the brand because I haven't heard about it.

Aware. I've heard of it but am not sufficiently persuaded by anything I have seen or heard to buy it.

Accept. I have heard of the brand and I accept it as qualified to be in my brand set and I buy it occasionally.

Adopt. My experience of this brand has made me adopt it and I buy it quite regularly.

Adore. This is my brand of choice for the needs it meets; I buy it on every possible occasion, in fact I would go out of my way to buy it and avoid situations where it is not available. I recommend it to others.

As customers ascend this continuum, their improving attitudinal commitment turns into behavioral commitment: This brand is responsive to my needs; I have confidence that it will always meet my needs; I have trust and respect for all the brand's offerings. Therefore, behaviorally: I make repeat purchases to enjoy the relationship I have with the brand; I make a point of belonging to a community of brand users who are smart enough and like-minded enough to share their loyalty to the brand; I am ready to recommend the brand to others; I am willing to pay a premium for the brand because I experience not only better value but also the emotional rewards of loyalty; and I am confident about trying any new offerings the brand might present to me from time to time.

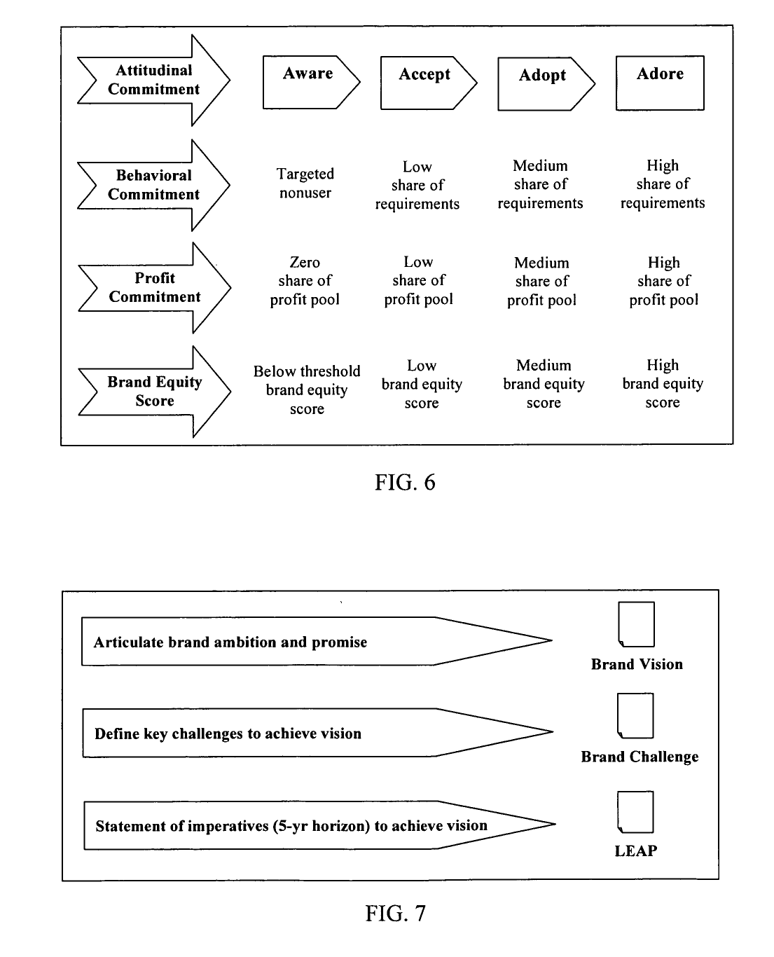

As a result of these increasing commitments, customers will try a brand, or continue to buy a brand (i.e., exhibit brand loyalty), and allocate a brand a greater share of their expenditures in any given category. And if they truly love the brand, they will be more likely to try anything new within a brand's domain that it introduces to the marketplace. FIG. 6 details the process and metrics that can measure the power of brand commitment.

Brand equity is associated with high brand loyalty. High loyalty is associated with high margins. If you have my loyalty, you do not have to give your product away and you do not have to reduce its price, so you can increase your effective brand margin; you do not have to promote as much, people come to the store or the website and will choose your brand anyway. So, brand loyalty can be measured by repeat purchase or share of requirements. These are good metrics for measuring brand loyalty.

Brand equity can also close a credibility gap for product performance and reliability. Customers will pay more for the risk relief and confidence they get from known and trusted brands. Christensen and Raynor describe this, “When customers aren't yet certain whether a product's performance will be satisfactory, a well-crafted brand can step in and close some of the gap between what customers need and what they fear they might get if they buy the product from a supplier of unknown reputation. The role of a good brand in closing this gap is apparent in the price premium that branded products are able to command in some situations.” (See Clayton M. Christensen and Michael E. Raynor, The Innovator's Solution: Creating and Sustaining successful Growth, Boston: Harvard Business School Press, 2003, p. 163). Therefore, making customers more committed through stronger brands leads to higher levels of revenue growth, cash flow, and profitability.

For B2B brands, the equivalent of the 4 A's continuum is termed “affective commitment.” While B2B customers will probably not tell you that they adore your brand, they show the same low, medium, and high levels of commitment. If they have the fullest level of trust in the brand and have had a long-term, positive experience with it, they will show the same commitment to allocate the fullest possible share of dollars they spend in the space to the brand, they will be less focused on list price and more on the total solution the brand delivers, they will be more open to trying new products and services the brand brings them, and they will recommend the brand to others. Customers at the top of the commitment continuum will generate high revenue growth and high margins.

Note that affective commitment is a lot different from customer satisfaction. The latter is a snapshot, a moment in time; it provides a satisfactory answer to the question, “What have you done for me lately?” Affective commitment has a projection of future loyalty and future cash flows that customer satisfaction lacks.

According to Doyle, “the present value of a brand's future cash flow is a function of four factors: the level of its cash flow, the speed it comes in, the duration it lasts, and the risk of these future returns.” (See Peter Doyle, “Shareholder-Value-Based Brand Strategies,” Brand Management Vol. 9, No. 1, Sep., 2001, pp. 20-30,). Brands drive cash flow growth in four ways:

Higher Levels (premium pricing, broad product bases, deeper/penetration/higher usage rates, ubiquity);

Faster (new item distribution; time to market; fast turns);

Longer (consumer loyalty; equity strength; equity consistency); and

Less risky reliable/predictable revenue stream).

Among consumers who have a weak brand perception, the brand will achieve little penetration or loyalty. Where brand perception is strong, the brand will achieve increasing loyalty, with a consequent increase in the level, speed, duration, and reliability of cash flow and revenue. It is the task of marketing—specifically, brand building—to increase the quality of perception among more and more customers. The challenge in building brand equity is to increase variables such as the affective commitment and the behavioral commitment to the brand. In order to start on the journey to building brand equity, every brand should have a brand vision, a brand challenge, and a LEAP, as illustrated in the brand equity framework process which is presented in FIG. 7.

Brand Vision

Brand vision is an expansive, ambitious statement of what the brand could be and where you could take it. Determining the brand vision is the first step in the brand equity framework process. The brand vision is the long-term goal we set for the brand. It is a stretching, deliberately ambitious goal that sets the direction for the brand over the next three to five years. Usually, the vision describes the ownership of a desired high-level emotional benefit or equity that a brand seeks to own outright (versus competitors). The brand vision process steps are depicted in Table 1.

If you've conducted a domain strategy exercise and mapped the domain and its boundaries, you know that you can take the brand beyond its current category boundaries. You may even believe you can be the first to see the potential in the domain and that your brand can “own” the delivery of the high-level benefit that defines the domain. Or you may simply see pathways to growth that weren't obvious before the domain strategy was developed.

Creating the brand vision is an iterative process. It starts by identifying the consumer-defined emotional space described in the doman strategy process. Once that space is identified, the marketer must create the hierarchy of customer needs relevant to the space. These needs start with the prosaic “price of entry” functional benefits (“the tires fit my car and roll smoothly”) to the highest “terminal” value (“the tires keep my children safe and fulfill my responsibility as a parent”). Then the marketers must create an equity map of current brands. What spaces (benefits) do they own? How secure is their ownership of a specific benefit? This allows the marketer to create an initial opportunity statement describing the brand's opportunities in functional, and especially emotional, terms. From this opportunity statement evolves the Brand Vision Statement, a comprehensive but concise one-page document comprising 10 components.

TABLE 1
Brand vision process

| Component | How It Is Used |
|---|---|
| Brand Ambition | Desired state-what the brand can become |
| Rationale | Why we believe BV is desirable/achievable AND the |
| | consumer-centric/business metrics that demonstrate |
| | rationale for achieving the Brand Ambition |
| Key Customer | The new/revised customer and brand insights that have |
| Insights | helped us redefine our brand vision |
| Future/New | A simple statement of what our brand will promise to |
| Brand Promise | customers in terms of highest-level, emotional benefits |
| Rational/ | Support for Brand Promise from the functional, |
| Functional | performance, product, and technology basis of the |
| Support for Brand | brand |
| Promise | |
| Brand Essence | Brief statement-developed via the Brand Essence |
| | process-of the core essence of the brand |
| Target Audience | Key audience descriptors, extending beyond verticals |
| | to their consumers' attitudinal, psychographic |
| | segmentation information |
| Desired | How we will seek to connect with our customers in the |
| Relationship with | future-their expectations, motivations, and drivers |
| Customers | |
| Competitive | Articulation of other competitive brands in the space, |
| Environment/ | including their vision, and/or expected competitive |
| Context | reaction/intentions |
| Executional | Key brand properties that may evolve or need to be |
| Properties | considered as we scope out new opportunities; includes |
| | Brand Architecture |

Domain strategy releases brand vision from category-bound and product-bound thinking, and refocuses it on consumer needs-based thinking. Once the domain has been identified, a consumer hierarchy of needs can be constructed for the primary consumer needs uncovered in the domain. The hierarchy of needs is Maslovian—it is based on the premise that, having met their needs on one level, consumers continually strive to ascend to a higher level of need and to meet those higher-level needs. Classically, the hierarchy has functional needs at the bottom, and progressively more complex needs—for safety, belonging, love, and esteem—are ranked progressively higher. At the very top are the highest needs, for self-actualization and spiritual improvement.

If consumers link these highest need states together under a single overarching need state, then they will be very likely to accept one brand that can deliver them all. A bold brand can be very ambitious in this situation.

Referring to Table 1, the brand vision should be a comprehensive document that sets out the brand ambition (where will this brand be in five years time), and the brand promise and rationale for the promise. This is quite close to a positioning statement—the brand promise is the single benefit that the brand will deliver to the customer in order to attract more users and generate increasing loyalty. This promise is invariably an emotional benefit. It doesn't matter whether your brand is operating in a B2B space or a B2C space, or even if it seems to be focused on the most functional and operational characteristics. Customers don't just buy products and functionality. They don't even just buy reliability (keeping the promise). They buy relationships, and relationships are based on emotions—trust, confidence, and a feeling of comfort at minimum; sometimes escalating to a feeling of exhilaration or a sense of accomplishment.

The rationale for the promise is the reason the customer should enter into this relationship with a desire to realize the end benefit. The rationale can include functional reasons—for example, “our product is so well made that you can trust its reliability.” But it must also have an emotional reason—for example, “our company is so committed to your winning that you'll feel like you have an army of energetic support behind you.”

The task of the brand vision is to capture both the rational and emotional support for the brand promise, not only as accurately as possible, but in a way that both reflects and drives the culture of the brand and makes it credible and deliverable. In the new world of brand-led growth, it is critical to unleash the brand-building power that's inherent in every employee. Everybody does brand building in the winning company of the future. To do so effectively, everyone must live the promise and be part of its rationale. The brand vision is both the blueprint and the code of conduct for the brand-building team.

Brand Challenge

In creating a brand vision, there is freedom—and indeed necessity—to be expansive and ambitious. We must stretch to know what is possible, and it requires unconstrained thinking to do so. The next step is to be candid and objective. Can the brand realistically achieve the vision? If so, what are the barriers and obstacles that must be overcome? This is the brand challenge. Features include: articulating the gap between the brand vision and the current state which enables an understanding of the task at hand; and articulating the current gap with reference to the brand commitment continuum which enables the application of metrics to the gap, and to monitor each year (or any other time period) the progress in closing the gap or meeting the challenge.

In addition to the brand vision, the brand challenge phase requires: the brand health summary, which defines the current standing of the brand with the target audience as measured by sales, consumption, and brand equity scores; and the brand commitment profile, which measures consumers' behavioral loyalty to the brand.

The objective definition of the brand challenge should be addressed in two ways: words and numbers. In words, the brand challenge should clearly set out the tasks to be accomplished. Examples include: increase penetration among small businesses of $50 million to $250 million in revenues, from 5 percent to 45 percent.; increase the share of requirements the brand commands among the top 1,000 customer targets from 17 percent to 24 percent; and increase the brand gross margin by 2.5 percentage points by increasing it 0.5 percentage points each year for five years.

Brands too seldom describe their targets with such clarity. The benefit of doing so is that it forces the brand owner and brand manager to confront reality: Can these goals realistically be achieved? Are there any historical parallels that suggest that the achievement is feasible? Are there any marketing strategies that suggest the likelihood of success?

Senior management might well be reviewing many brand challenge documents, either from many different brands if they are managing a multibrand business, or from many different business units that are applying a monobrand in multiple categories. By reviewing these brand challenge documents side by side, they can make decisions about the relative likelihood of success of the various options in front of them, and allocate resources appropriately.

The brand challenge in numbers is an unvarnished set of data indicating where the brand is now, where it needs to be in the future, and the annual milestones to get there in a five-year period. For example, if the brand commitment profile suggests that it will be necessary to both double penetration and double the number of customers in the highest affinity quadrant, while maintaining the current share of requirements commanded by each affinity segment, the brand challenge might look like Table 2:

TABLE 2
Brand commitment profile

| | Unpenetrated | “Accept” | “Adopt” | “Adore” |
|---|---|---|---|---|
| year 0 | 50% | 20% | 20% | 10% |
| year 1 | 45% | 21% | 22% | 12% |
| year 2 | 40% | 22% | 24% | 14% |
| year 3 | 35% | 23% | 26% | 16% |
| year 4 | 30% | 24% | 28% | 18% |
| year 5 | 25% | 25% | 30% | 20% |

The brand challenge in numbers provides yearly milestones to check progress, and becomes the basis for the five-year targets in the long-term equity appreciation plan (LEAP), which is discussed elsewhere herein.

Similar brand challenge numbers can be generated for the brand equity score necessary to drive an increase in penetration and loyalty, as well as for targets in revenue growth and brand gross margin growth that result from the overall improvement in brand equity.

Building brand equity provides financial advantage for higher, faster, longer-lasting, and more secure cash flows. This is the core task for marketing. Creating the processes for brand vision and understanding the gaps to close in achieving universal customer belief in that vision—through the brand challenge—are key to expanding growth both in scope of products in more profitable new categories as well as improving profits for existing product offerings. This process requires a long-term commitment to equity appreciation.

Long-Term Equity Appreciation Plan and Brand Imperatives

LEAP

So, now you have identified the brand vision and the brand challenge for your company or brand. How do you convert these into an actionable plan for building brand equity?

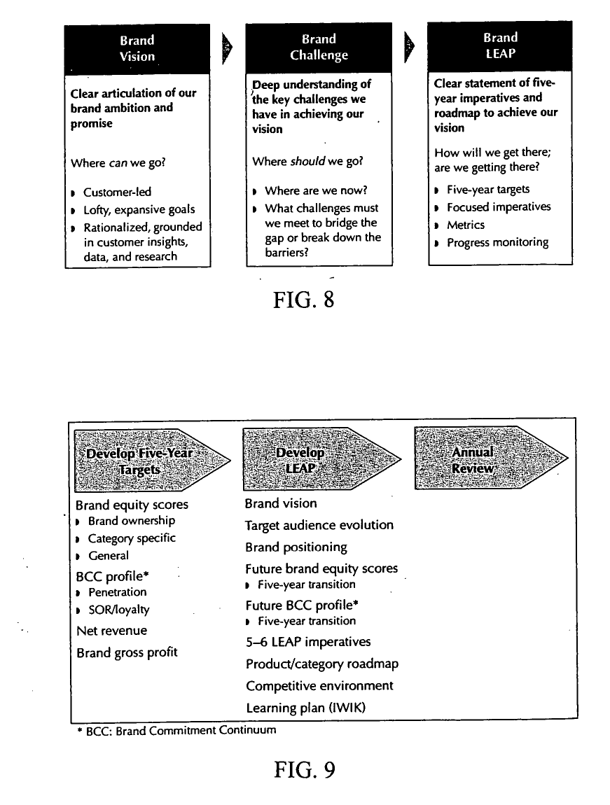

The process for moving forward requires a long-term equity appreciation plan (LEAP). The LEAP provides the five-year plan to bridge the gap between the brand challenge and the brand vision. FIG. 8 illustrates the LEAP process.

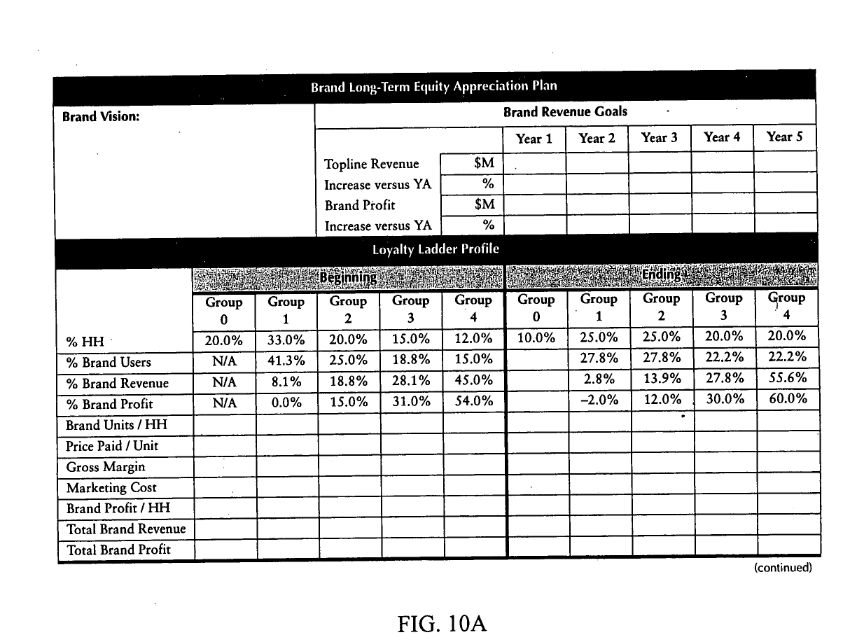

As illustrated in FIG. 9, the LEAP process itself includes three phases: developing five-year targets, developing the LEAP, and conducting annual reviews to monitor and refine the LEAP.

The components of LEAP are detailed as follows:

The Five-Year Targets for the Brand

The brand creates two types of targets. Attitude (equity) targets and behavior (purchase) targets. The attitude or equity targets are measured by a series of metrics that capture consumer perceptions across the full range of the consumer experience. The behavior targets are expressed in terms of market penetration (the percentage of consumers using your brand) and the revenue or purchase volume per customer (often expressed as “behavioral loyalty”). Let us discuss each of these in more detail.

Equity goals. Equity measures the attitudes that drive revenue and growth via the brand equity monitor (discussed elsewhere herein). There are three types of brand equity scores, and the coefficients of each one as a driver of brand revenue growth will be developed over time based on business results. The LEAP articulates three sets of brand equities: (a) Desired equity ownership unique to your brand-the single high-level equity we desire to own; (b) Category-specific drivers that define what it takes to win in the category—Those equities that we know drive preference and purchase intent within our category; and (c) General equity drivers that determine the strength and stature of any brand—Usually the standard differentiation, relevance, esteem, knowledge.

Over time, we seek to build a direct link between the brand equity scores and the brand revenue outcomes, in the form of a coefficient or a correlation factor. Progress against the five-year brand targets can be tracked through the brand equity monitor.

Customer behavior goals. The brand equity goals measure attitudes. The LEAP needs to measure behaviors because behaviors translate directly into revenues. We advocate measuring three simple metrics: (1) the percentage of the marketplace that has purchased your brand at least once in a relevant time period, (2) the number of times they have purchased your brand during that time, and (3) your brand's percentage of total revenue spent in the space. As we discuss elsewhere, almost any marketing problem can be addressed by understanding these three simple metrics.

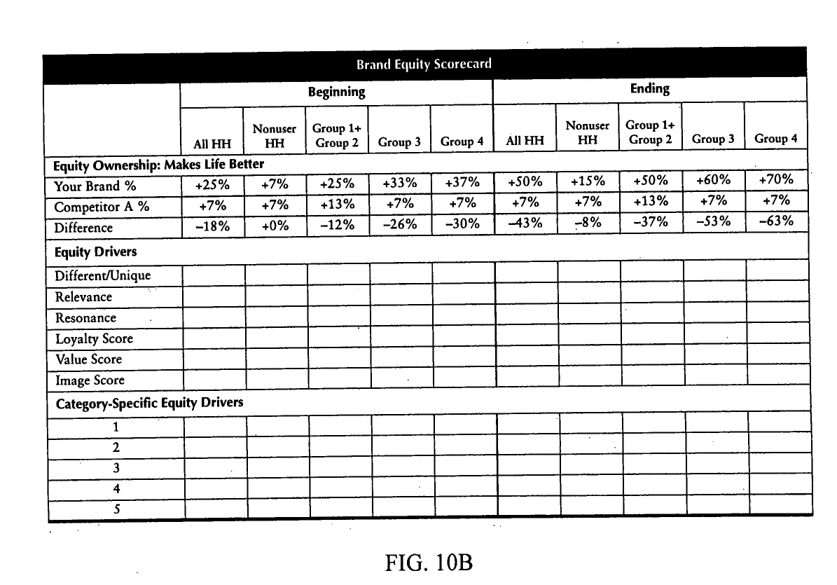

A five-year LEAP can be qualitatively and quantitatively depicted as the progress of a consumer along a “brand commitment continuum,” in which nontriers become occasional triers and current triers give a greater and greater percentage of their total category needs to your brand. Understanding who these customers are, and how to move them up that continuum is at the heart of marketing and LEAP development. FIGS. 10A and 10B illustrate examples of the goal-setting template for brand equity and penetration and loyalty metrics, showing a brand long-term equity appreciation plan, a loyalty ladder profile and a brand equity scorecard (described in detail elsewhere herein).

Brand Imperatives and Initiatives

Once the goals are set, the next step is the creation of what we call imperatives—the major strategies required to bridge the gap between vision and challenge.

In this component of LEAP, you determine the key strategies on which to focus over the coming five years to progress toward your brand vision. We call these major strategies imperatives. Others may call them expressions of strategic intent. The LEAP document outlines these imperatives and the high-level description of the projects that will be pursued to deliver on each imperative. Note that each of the imperatives can be measured on a scale such as the brand commitment continuum.

Imperatives express a specific strategic intent the brand must realize to close the gap between brand vision and brand challenge over the long term (five years). Initiatives are the programs to turn the strategic intent of the imperatives into marketplace reality. LEAP is deliberately designed to provide the metrics framework for defining and tracking success—identifying the equities we wish to own, and the specific measurements that are our year-by-year goals. We map imperatives from Year 1 to Year 5 in order to set the vision and expectations for the key initiatives that each imperative will generate over time. Each initiative in turn is linked to an aspect of the metrics it is supposed to drive.

Imperatives are typically few in number—no more than five or six. Their purpose is to concentrate effort, resources, and development on the few strategies that truly matter in achieving the brand's targets. The actual imperatives can vary by brand and business situation, but essentially there are five common types of imperative: (1) Brand commitment profile enhancement; (2) Advancing into new domain spaces; (3) New product, service, or solution development and innovation; (4) Communication; and (5) Channel management. Other imperatives might include refinements in marketing mix, investment mix, or line extension development. Each of the five priority imperatives will now be discussed in detail.

Brand Commitment Profile Enhancement

The goal of making the brand more relevant to more people in more parts of their lives is monetized via new penetration and higher loyalty (i.e., a higher share of the customer's requirements devoted to your brand). Customer loyalty and usage rates are the engines of unit, revenue, and profit growth as defined by behavioral brand commitment. You must have an understanding of the specifics of your brand's growth model and be able to focus on the development of a marketing plan and set of tactics geared to that model.

Advancing into New Domain Spaces

The strategic execution of the brand-led growth imperative (i.e., that brands grow by becoming more relevant to more people in more parts of their business or personal lives) is domain strategy, as reviewed elsewhere herein. One LEAP imperative will include the elevation of growth targets via advancement of the brand into these new spaces.

New Product, Service, or Solution Development and Innovation

The second most important influence on brand equity and brand perception is a positive brand experience. This is delivered by a product that performs consistently at or above the level of customer expectation. The product must support the delivery of the benefit. Even though emotional aspects of the brand positioning are more fundamental to achieving equity ownership than are rational aspects, the brand cannot win on the emotional plane if the product fails to deliver on functional excellence. Continuous and inspiring innovation is necessary to retain category leadership and expand to higher growth and higher profit categories.

Communication

Through strategic development and delivery of communications, the brand can develop the equity ownership to achieve LEAP success. Remember, brand equity is a perception in customers' minds. Ownership of brand equity means that customers associate your brand with successfully meeting the high-level need they feel, much more than they associate any competitive brand. Communications and all the touch points of the customers' experience with the brand's products and services build perceptions. The full range of communications is contemplated in this imperative: advertising, public relations, events, in-store promotions, website, Internet viral communications, and personal service.

Channel Management

To be successful in delivering end-customer value, the brand must also be successful in delivering value to the channel partner. In packaged goods, that's a retailer like Wal-Mart; in high tech it's a distributor or reseller; in businesses like Mary Kay cosmetics, it's the individuals who represent the brand directly to the consumer; for an online retailer it might be Yahoo! Shopping. By creating value for the channel partner, the brand can obtain superior retail or web presence or “mind share” and improve its opportunity to make sales and realize revenue. By translating the higher-level customer benefit of the brand vision into a higher level of channel partner value, the brand can make the channel a partner in growth. Examples include higher channel margin through premium pricing, the attraction of a higher-spend customer to the retailer's outlets, or the development of storewide programs based on the brand's insights mapped to the channel partner's shopper profile.

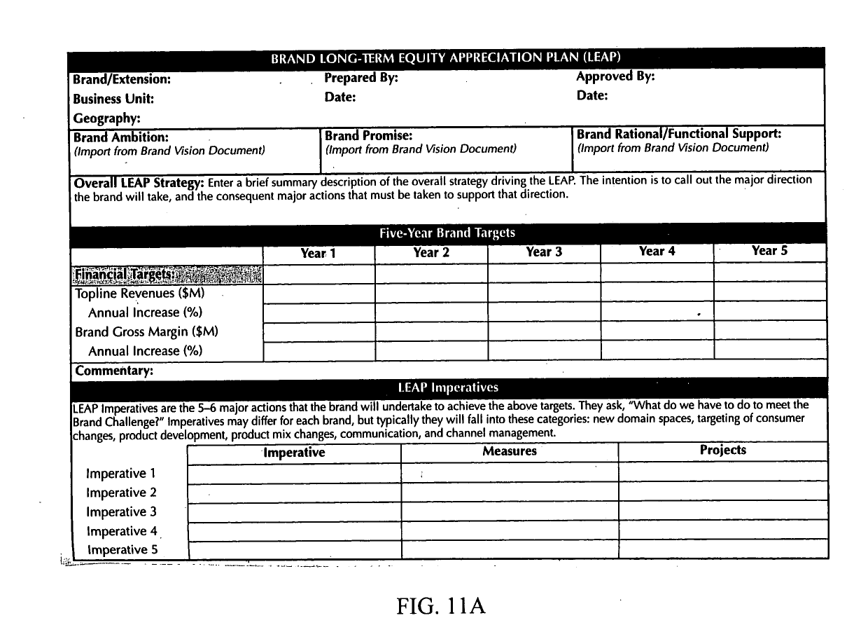

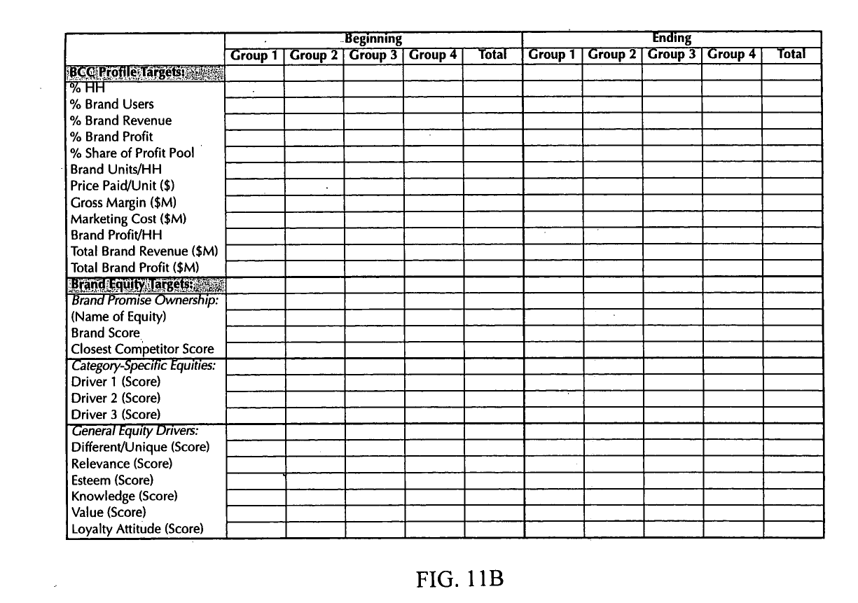

A template for a LEAP is illustrated in FIGS. 11A and 11B and described below.

The brand equity framework process is intended to be an iterative process—you may not get the brand vision right the first time, in which case it will require another review of the voice of the customer and customer domain and the options open to the brand in pursuit of equity ownership. Ensure both that the brand ambition is sufficiently stretching, and that it can rationally be achievable over three to five years.

The choice of the single equity you seek to own will drive all long-term equity planning and all LEAP imperatives. Is it the highest point on the hierarchy of needs your brand can attain? Can you own it versus competition?

You have a choice among all the category-specific equities and general equity drivers where you seek to lead versus competition. Have you chosen the ones that are most important to your customers?

The right mix of imperatives should ensure that every brand activity is focused on achieving the financial goals resulting from equity ownership. Typically, imperatives should cover equity ownership via communications, superb customer experience via product development, entering new domains, category growth strategy in current categories, and channel marketing.

Are there ways to phase the imperatives so that there is a plan to focus on building a base in the early years of the plan and expanding on that base in the later years? For example, you might concentrate on creating product breakthroughs in the early years, and investing in capturing brand growth with them in the later years.

The initial brand equity development (“Year One” of the five-year LEAP) will properly seek to identify the precise equities for the brand to own, based on a thorough understanding of customers' domains and the customers' hierarchy of needs.

After the identification and articulation of the correct brand equities, execution and measurement against them will follow, guided by the LEAP imperatives. After a defined time period, you will begin to measure the impact of your actions on customers' attitudes and perceptions of your brand. The brand equity monitor discussed elsewhere herein will highlight changes in brand equity scores and their correlation with financial performance. The brand commitment profile model will also help you track movements in behavioral loyalty; that is, how shifts in brand equity perceptions are translating into changes in share of requirements.

With these two sets of data in hand, you should revisit your brand challenge and your LEAP. You may assume that your brand vision is correct at this point, and that you have identified the right future path for your brand. If your brand vision needs modification, you should begin the brand equity framework process from step one—with customer insights. However, this is a major re-evaluation and should only be carried out after deep consultation with senior management.

Your brand challenge however, will need to be updated to periodically reflect the gains you have made against the objective—what are the gaps you have narrowed, or even closed this year through execution against the imperatives? Perhaps you have launched a series of new products that enable your brand to better stand for a certain benefit or that meet a certain milestone on the road to your brand ambition. It is unlikely that after one year you have fully met the brand challenge; if you have, then your brand ambition was not stretching enough! But you may have made enough progress to advance the boundaries of the LEAP five-year targets.

Your LEAP will need to be updated with new equity scores and changes in the brand commitment profile. You should be able to assess how well you are doing, and which priorities to rearrange as you go forward into the next time period.

Customers' tastes, habits, and preferences are constantly in flux, and this has been accelerated in recent years by the vast increase in new products in many categories. Consider the proliferation of adult beverages—“premium vodkas,” new categories of ready-to-drink, premixed products. Consumers now find room in their consumption habits for products they would never have considered.

Therefore, you must constantly monitor customer preferences and behaviors. The boundaries of domains will shift as customers are offered new benefits that enhance their experiences, even within the same categories. Think of the explosion in sports equipment and accessories that have accompanied the rise in mountain bikes, yoga mats, hiking boots, and the like, giving rise to new opportunities for manufacturers to stake out new product and emotional territories.

If you have developed a sound insights process, it will constantly feed into your brand development process, helping you identify, understand, and react to any shifts that occur. Now, that does not mean that you should change your brand vision to match the latest fads. You want to stay on the leading edge of understanding where customers' preferences are heading. This will enable you to evaluate, test, and make bold decisions on new products and benefits that your brand can take advantage of. Moreover, thinking of the customer as a moving target prevents the “lock-in” effect, where benefits and insights are handed down to each new member of the brand team, seemingly unchallengeable.

Each year you will need to assess your progress against the brand vision, and update your brand challenge document and LEAP accordingly. These should then be shared and inculcated as part of the annual planning process.

In summary, the LEAP provides the vehicle for linking brand imperatives and initiatives into an actionable blueprint for building brand equity based on the brand vision and brand challenge. All aspects of brand-building imperatives including advancing into new domain spaces, new product, service and solution development, brand commitment profile enhancement, and communication and channel management, should be considered. While there are many valid models for choosing metrics, the marketing managers should have the responsibility to help fashion the metrics that are right for the brand and have them adopted by senior management.

Brand Implementation

Integrated Marketing Strategy

One of the great challenges in marketing management is assembling the right combination of vehicles to deliver the objective at the lowest possible cost. The optimal solution almost always requires a range of complementary elements and the question becomes: “What's the right balance of ingredients?” Under some conditions, marketers have powerful new weapons, such as market mix modeling and agent-based modeling to help answer the question of spending allocation. But under all conditions, marketers can enhance their chances of obtaining the right answer by adopting what we call “integrated marketing strategy” . . . what others call “cascading choices.”

The principles are simple: (1) understand the objectives of each initiative clearly, (2) build a “custom” solution by choosing marketing vehicles in descending order of their capability in achieving the goal, and (3) never underspend on a higher-priority vehicle in order to find funding for a lower-priority vehicle.

Traditional marketing models are dissolving rapidly because there are so many more touch points for marketers to consider. The range is baffling. Brands today are built via the Internet touch point, the doctor's office visit, the phone call to the 800 number, sports sponsorship, and advertising delivered via the car radio while the customer drives to work in the morning, to name but a few. The traditional marketing weaponry—the mass market TV campaign in B2C and the direct sales force in B2B—are delivering lower returns on the high investment cost required to sustain them.

If you are managing a B2C brand, the mass market TV vehicle no longer communicates your message to your target consumers with the same efficiency. The way customers capture and process information relevant to marketing has changed more in the past decade than at any other period since the post-WWII development of TV as the primary advertising medium. If you are managing a B2B brand, the returns from person-to-person selling can't keep pace with the cost of keeping a sales force on message with all the latest data required to support solution marketing via relationship management.

Mass marketing has also become relatively expensive. Over the last 20 years, while annual inflation is up less than 5 percent, the annual increase in the cost of television advertising is closer to 10 percent. All these factors are changing the dynamics of how organizations view targeted marketing, which provides better value and the ability to more accurately measure the return on investment for each element in the marketing mix.

Market mix modeling breaks the trap of the one media vehicle or targeting approach strategy that inhibits marketing resource allocation effectiveness. At one end of the strategy spectrum are mass marketing and the direct sales force, both artifacts of the 1950s. At the other end of the spectrum is “one-to-one” marketing, which has also proven to be flawed. Direct mail response rates for consumer financial services are at an all-time low because of the category's abuse of the medium, and only a handful of major brands have demonstrated the appropriate understanding of the brand imperative to develop the customized selling capability via the Internet to the point of achieving critical mass.

But in between these extremes there are a host of opportunities to increase the efficiency and effectiveness of brand building by eschewing the wasteful “empty calories” of mass marketing and substituting the “protein-and-fitness” regimen of sophisticated, scientific targeting. Targeting is an element of marketing strategy that, too often, is paid mere lip service. A little thoughtfulness and analysis would go a long way to making your media, direct-to-customer, promotion, and PR dollars significantly more effective and efficient. CEOs should harness every stimulus for improved targeting to accelerate brand growth.

An integrated marketing strategy (IMS) will address the issues created by a blinkered approach to marketing. The IMS will integrate the efforts of the relevant marketing functions to deliver the results for the brand. The IMS will:
(1) Start with a clear identification of the initiative that the brand is trying to achieve and the objectives related to that initiative;
(2) Identify the extent to which each marketing function will help achieve an initiative's objective and the role that each function will play;
(3) Use existing customer knowledge and insights to create a strategy that addresses the marketing task at hand;
(4) Develop the strategy without getting into the tactics of how each function will deliver its share of the objective; and
(5) Identify the optimum marketing spending to help achieve the objectives.
   A great IMS has the following: (1) A well-defined target customer; (2) Detailed customer knowledge and learning; (3) Clearly defined initiatives with measurable objectives; (4) A clear description of the marketing task at hand; (5) Synergistic functional strategies; (6) The ability to make cascading choices and not try to do too much with too few resources; and (7) The ability to be flexible and adopt to market changes.

Table 3 outlines the process for developing an integrated marketing strategy for a brand:

TABLE 3
Integrated Marketing Strategy Process

| # | Process Step | Comments |
|---|---|---|
| 1 | Identify and profile | The “who” of each initiative is not just a demographic |
| | the potential target | segment but also contains information on their attitudes, |
| | customer | behavioral traits, and any relevant customer knowledge |
| | segment(s) for each | and insights. |
| | of the initiatives. | |
| 2 | Prioritize the | The potential segments are prioritized based on size, |
| | segments for | competitive strength, appeal of initiative offering, past |
| | actioning the | history of the brand with the customer segment, and |
| | initiatives (if | strategic interest of the segment to the brand. |
| | relevant). | |
| 3 | Identify the | Identifying the attitudinal barriers focuses the team on |
| | attitudinal barriers | the task at hand and assists in short-listing the marketing |
| | to make the | vehicles. |
| | behavior change in | |
| | customers. | |
| 4 | Shortlist marketing | The marketing vehicles are shortlisted based on the task |
| | vehicles | at hand, available budget, and initiative timing. |
| | accordingly. | |
| 5 | Review integrated | These are the “cascading choices”-among marketing |
| | strategy options. | vehicles based on the understanding of the objective and |
| | | the effectiveness and efficiency of each marketing |
| | | vehicle in meeting similar objectives in the past. |
| | | Choices are filtered through budget constraints. The |
| | | conceptually “best” choice will not work if there is not |
| | | enough budget to reach critical mass. In that case, |
| | | choose the next best option that can be fully funded. |
| | | Also consider results that indicate that two options |
| | | working together are more effective than either one on |
| | | its own-the 1 + 1 = 3 phenomenon. For example, a sales |
| | | call plus a free sample might deliver more penetration |
| | | gains than either option on its own. |
| 6 | Select the | If two or more vehicles are very similar in their ability |
| | appropriate IMS. | to support the initiative, or if there are potential |
| | | synergies in using more than one vehicle, allocate |
| | | marketing dollars to marketing vehicles using market mix modeling |
| | | or agent-based modeling. |

A critical issue facing brand managers is the optimal allocation of funds among a wide range of spending options. We have reviewed best practices across dozens of companies. No company seems to have a comprehensive, holistic, integrated approach to address this basic requirement of marketing management. Most companies impose some primitive fiscal discipline. They do not explore each component of the plan and apply a rigorous reasoning to each one, model the trade-offs, and then allocate funds across the alternatives to maximize profitability.

There are several reasons for this failure. The most common is the excuse, “We don't have the data.” This begs the question, “Why not?” Isn't it the responsibility of marketing to develop the data that enables responsible fund allocation? One of the significant failures of modern marketing leadership is its unwillingness to spend $250,000 to get adequate market mix modeling data and its simultaneous willingness to spend $20,000,000 on marketing without adequate models or data.

Scholarly dissertations have been written on the strengths and weaknesses of market mix modeling. Suffice it to say that the cost, complexity, and admitted limitations of the technique have often discouraged marketers from making the financial and intellectual effort to use this powerful tool.

This lack of determination by marketing management to utilize this tool is remarkable given the fact that the cost of a market mix modeling study is generally 1 percent or less of what a typical company spends to support a major brand. The simplest math would indicate that a market mix model study would pay out with less than a 1 percent improvement in the spending allocation of a brand. Yet many CEOs, CFOs, and marketing managers are simply unwilling to make that expenditure. Their resistance should be decreasing every day, especially in business verticals such as financial services, pharmaceuticals, telecommunications, and retail, where rich and highly granular data facilitates the most sophisticated analysis.

One criticism of market mix modeling is that it is dependent on masses of time series data that are not available for many of the more unusual and contemporary marketing vehicles. That being said, adopting an integrated marketing approach has recently been made easier by the application of a new modeling technique—agent-based modeling. Chances are that your children are familiar with agent-based modeling in the form of popular simulation games such as Sim City. These games employ principles of agent-based modeling that are also used by the Department of Defense to do “war gaming” and by others in various academic pursuits such as sociology and cultural anthropology.

Agent-based modeling enables a company to model virtually all marketing inputs—without the data limitations imposed by traditional market mix modeling—and to rank order the relative contribution of these inputs to share and profit gains. In comprison with other modeling techniques such as statistical regression, conjoint, and test marketing, Agent based modeling provides enhancements in such assessments as explaining market dynamics, adaptability to change, scope, questions addressed per model, breadth of market behaviors modeled, accuracy within scope, use of data and cost per projection/question.

In summary, each marketing initiative requires a customized solution that we call an integrated marketing strategy. That strategy is characterized by a clear target consumer, rigorous goals, and a considered weighing of the ability of a specific tactic to meet the goals. Under optimal circumstances, advanced techniques such as market mix modeling or the newer agent-based modeling can help marketers arrive at the proper balance among numerous marketing alternatives. In the absence of such tools, an orderly process such as the one advocated here (“cascading choices”) will yield an improved result for virtually all marketers. This is the technique being used to great effect by the world's most sophisticated marketers in venues where data is scarce and advanced tools impractical.

Excellence in marketing requires familiarity with a broad panorama of academic disciplines, from psychology to anthropology, from sociology to economics and finance. Indeed, many marketers were originally attracted to marketing as a profession precisely because it covers such a broad swathe of the human experience.

Just as marketing covers a broad range of academic disciplines, its successful execution requires a similarly broad range of functional skills. And herein lies another challenge. The best strategies can be negated by poor execution caused by functional failures. Yet few marketing leaders possess the capacity and stamina to master the intricacies of all the diverse functions of modern marketing, including: New product and service development; Package or store design; Retail loyalty card marketing; Advertising creative development/agency relations; Advertising production; Media buying including emerging new media; Merchandising at the point of sale; Direct marketing including e-marketing; Building brand equity through the sales force; Customer promotion; Event marketing and endorsements; PR; Market research and market mix modeling; and Training

Each of these takes years to master and when one feels that the subject has been mastered, change often intervenes to introduce uncertainty. So, each functional expert has his own experience of “Zeno's Paradox” as the goal of perfect knowledge always recedes from view with each individual step forward in functional skill.

Now here are several specific steps you can take to ensure functional excellence in brand implementation.

1. Provide your Functions with a Marketing Knowledge Center.

Every function will perform better if its members have a panoramic understanding of the business plus access to best practice examples across the spectrum of marketing, and not just in their own functional area. The function may have its own “pages” within the company's marketing knowledge center, but should also focus on understanding the entire brand-building process and not just their part in it. In addition, web links to functionally specific thought leading sites are a good way to keep functional leaders thinking about improvement. For example, numerous links are readily available to websites on consumer research and modeling where any one could receive all the necessary background on new developments such as agent-based modeling. Many trade and academic organizations run excellent websites on subjects such as forecasting. Yahoo has industry- and discipline-specific chat rooms that are valuable information sources and stimuli.

2. Use Functional “Landscape Reports” to Stimulate Functional Improvement

These reports have many benefits in the overall EMM Way of Brand Building. Their primary benefit is to align all functional groups around a common view of reality so that planning can proceed on a sound factual basis. But one of the greatest values of the landscape is causing functional leadership to take a look in the mirror and report what's new in their function and to identify what they don't know (the “I wish I knews”).

3. Communicate the Long-Term Equity Appreciation Plan (LEAP) and the Brand Challenge.

Constantly require that every function's plans and practices reinforce the brand's equity. The most functionally expert department in your company is virtually useless if it isn't pulling its oar in the agreed strategic direction. One way to encourage functional alignment is to create a master creative brief and share it with every function. In a large, marketing-intensive organization that creates millions of customer contacts every day with everything from TV commercials to sales presentations and product data sheets, it is imperative that every customer touch be driven by a common master creative brief stipulating core message elements, tonality, logo presentation, and so on. That is the only way to multiply the message by thousands of employees.

The Master Creative Brief is one example of a process tool that ensures functional excellence in implementation by standardizing the inputs for creative marketing projects. It translates your Brand Vision into a concise and specific development framework to guide Functional Teams in developing their contribution to IMS. One of its primary roles is to ensure that the immense brand-building power of consumer insights (as captured in the Voice of the Customer) is carried through in a consistent manner into creative communications of all kinds. It includes a frame of reference, customer insights summary statement, brand promise, support and brand character, and is deliberately written in simple, bare-bones language. Finalizing the Master Creative Brief is the input to the start of functional development plans.

Introduction to Master Creative Brief

The Master Creative Brief translates your Brand Vision into a concise and specific development framework that will be used by all internal functional groups who implement the brand's communications strategy. Serving as the transition from the Voice of the Customer, Customer Domain research, and Brand Equity planning stages to the annual plan development and planning stage, the Master Creative Brief directs strategic creative development and ultimately dictates the success of your resulting communications and initiatives.

Deliberately precise, the Master Creative Brief is written in simple, bare-bones language. This ensures that each word is carefully considered, and communicates a meaningful, useful direction to the agencies and other users. The Brand Vision drives the Master Creative Brief that, in turn, becomes the foundation for your Customer Communications Strategy Briefs developed at the initiative level by the functional teams. Successfully executing these initial processes will help you achieve winning results in your functional strategies and projects.

The Master Creative Brief is the most important input you have in guiding functional groups' creative direction across all external brand communications. Senior representatives of the brand and the functional teams will approve and sign off on the Master Creative Brief before any creative development can begin.

Components of the Master Creative Brief

The Master Creative Brief draws from the Voice of the Customer and Brand Vision documents for the following components:

Frame of Reference: The Brand Ambition sets the context for the overall communications task at hand. It describes where you want to take the brand. You should also describe the expectations that you have of communications in helping you achieve the Brand Ambition.

Customer Insights: A very brief summary of the key customer insight that drives the Brand Ambition and must infuse all communications.

Target Audience: Taken from the Brand Vision document, the Target Audience describes in words who your brand advertising will appeal to.

Brand Promise: The high-level emotional benefit and/or brand equity that you are seeking to own. Taken from the Brand Vision document.

Rationale/Support: The emotional and functional reasons-to-believe your brand can offer the Brand Promise. Taken from the Brand Vision document.

Brand Character: How your brand will express itself, its tone and character. Again, taken from the Brand Vision document.

Executional Elements: Key brand elements that should be included in all communications. Usually confined to logos, iconic elements, and sometimes taglines.

Importantly, the executional elements should be reconsidered over time as you learn more about your brand and its appeal to your customers, but should not be changed with each execution.

Functions of the Master Creative Brief

The Master Creative Brief meets the following functions:

Joint agreement: The Master Creative Brief spells out the brand's direction and focus. In tune with the Brand Vision, the MCB clarifies and aligns viewpoints between you, your functional departments and agencies, and multiple layers of management, enabling you to better positively influence the creative development direction.

Source document: Clear and concise, this provides the necessary background without too much detail, so that the functional teams can start generating ideas. Most important, it illustrates how the brand's overarching vision translates into specific objectives for an individual project.

Insights transfer: The MCB ensures that there is a continuous thread linking Customer Insights (the brand's most powerful source of added value and competitive advantage) and customer communications.

Evaluation tool: The Master Creative Brief continues to be a significant tool even beyond the initiation of creative development. Since the first presentation of creative ideas can take place several weeks later, the Master Creative Brief acts as a quick refresher before reviewing and commenting on creative work.

Intellectual property: Over time, the Master Creative Brief is often one of the few sources of historical perspective behind individual advertising and communications executions. This can be a helpful source of past advertising strategies, key insights, and approaches to common situations (launches, competitive threats, etc.). Actual business results can be correlated to factors captured in the creative strategy. From these, you can draw conclusions about what should be reapplied in the future.

Understanding the power of your creative strategy can help you lock onto successful results in your marketing projects.

4. Require Your Functional Leadership to Capture “Best Practice” and Make it Available on the Marketing Knowledge Center.

In business, speed of learning is the only truly sustainable competitive advantage, yet most companies have no process and no mechanism for identifying, capturing, and then redeploying “best practice.” The key to functional excellence is knowing what has worked. Unfortunately, most companies do not systematically capture and build on this learning. They begin every year by turning to a new, blank page, ignoring past mistakes and successes. If they have learned, it's often through trial and error captured by the fragile and undependable memories of individual employees who regularly leave their immediate job, leave the company altogether, or simply retire with a lifetime of wisdom. The resistance among functional leaders to capture best practice, to codify it, and then to share it through technology and training is one of the great mysteries of business. At some perverse and possibly unconscious level, the resistance reflects the leadership's desire to magnify their own personal importance by abrogating all authority under the penumbra of their own ego. If no best practice has been identified and stored, the only best practice is what the leader says it is. For whatever reason, that is the prevailing condition in many companies.

This problem has grown exponentially as business has become a culture of face-to-face meetings entertained by presentations with funny face symbols and indecipherable graphs rather than one driven by tightly reasoned written memos with tables of supporting data and page upon page of written documentation attached.

In the functionally excellent marketing department, best practice is available 24/7 on a marketing knowledge center. A lesson learned and proven by experience is captured, vetted, approved, and mounted on the MKC.

5. Ensure that the Functions Know the Target Customer and How They Touch Him.

Every function touches the target in various ways. Every touch is an opportunity to reinforce brand equity and to SELL. The major hotel chains are getting good at optimizing touches. Their management realizes that the employees with the most frequent customer contact are the desk clerks, maids, and waiters—among the lowest paid employees in the enterprise. That's why today, it is virtually impossible to exit your hotel room in a well-run chain without receiving a cheery greeting from not only the front-line employees, but also the maids waiting in the hall to tidy the rooms.

6. Expect Every Function to Provide an ROI on its Expenditures.

Traditionally, marketing functions, especially those without readily available third-party data, have claimed ignorance or impossibility when asked to provide an ROI or metric of any kind. Now marketers are becoming quite creative in providing metrics when a determined manager simply refuses to fund someone's favorite but immeasureable idea.

7. Create a Process to Stimulate and Reward Functional Improvement

Ask each functional leader on an annual basis to present two things to their functional leadership peers: (a) the most important new development in their discipline over the past 12 months, and (b) the most important change that his function has made for your company. Have the functional peers choose the function that has made the most important change. Recognize that change financially and publicize it internally.

8. Reach out for External Stimulus

Demand that your functional leaders go to conferences and submit written reports on their learnings. Ask them to arrange for presentations by suppliers, consultants, and customers regarding functional issues of mutual importance.

9. Make Each Function Better by Enforcing Collaboration Through Process

Functional excellence is the second most desirable goal of any marketing organization. The most desirable is total marketing excellence characterized by building brand equity, delivering the annual profit goal, and adding to the understanding of the target consumer. The goal of individual functional excellence makes sense only in the context of the larger goal of overall excellence. Therefore, marketing leadership must ensure the functional collaboration to produce the higher goal. The key to collaboration is a process that embodies it. The integrated marketing process is the business tool to achieve this goal, and common metrics represent the supporting discipline that creates an atmosphere of collaboration by leveling the playing field.

In summary, functional excellence in brand implementation can be institutionalized through a rigorous process of self examination, benchmarking, analysis and archiving best practices. Marketing leadership can create functional excellence across the diverse skill base of modem marketing by a process of questioning augmented by the practices and tools discussed above. The essence of marketing leadership is making everyone in the department better by demanding the functional excellence that builds brand equity, the primary responsibility of the marketer.

Marketing Metrics

The purpose of marketing is to create or change attitudes that lead to desirable behavior. The outcome of doing so is that more customers buy more of your brand of goods or services at more favorable prices. There are a number of ways of looking at this outcome from the CEO's viewpoint:

Value creation. The net present value of the future cash flows from brand building translates into brand value that, in turn, translates into increased shareholder value, which is the CEO's main job.

Cash flow. Strong brands improve cash flows in four ways-higher, faster, longer, less risky. Free cash flow or EBITDA (earnings before interest, tax, depreciation, and amortization) growth would be another way of measuring brand-building outcomes.

Gross margins. One way of looking at brand-building outcomes is the higher gross margin that brands can achieve by commanding a premium price over alternative customer choices and by achieving a mix of customer purchases (for example, a product line that is 75 percent “regular price” and 25 percent “premium price”) that delivers, on balance, a higher margin.

There are examples of all of these outcomes metrics in use, but in the end we opt for the simplest of choices: top-line revenue growth and gross margin. Top-line revenue growth is the purest measure of marketing outcomes because that is marketing's job. Selling more goods and services to more customers at more favorable prices drives top-line revenue growth. Put more elegantly, we say that brand building makes your brand more relevant to more people in more parts of their (personal or business) lives, but it amounts to the same thing in terms of outcomes.

The top-line revenue growth metric can be refined in several ways. One is to look at net revenue growth. The word “net” implies that we have taken away some cost burden. In the case of marketing, many companies take away the costs of discounts to the customer to make the final sale. In a sense, marketing is responsible for the discounts, because the stronger the brand, the fewer and lower the discounts. Now, this isn't always true. Sales and accounting come up with many arcane ways to massage the difference between the list price and the net price. However, marketers should not resist the measurement of net revenues as their outcome, as opposed to gross revenues.

A second way is to look at revenue growth versus a baseline. This is truly marketing's focus. In year one of a brand's life, all revenue is growth revenue, and, in that year, marketing can rightly take credit for having directed the development of a brand that customers needed, and made them aware of it and induced trial and initial repeat purchase. In subsequent years, it is the growth in revenue for which marketing should take responsibility. The best way to look at this is growth versus baseline, or carryover. This measure assumes that there would be some level of revenue even if marketing did nothing to support the brand in the current year. Anything above that baseline level is the net positive effect of the incremental marketing support in that year. (This approach also accommodates those painful situations where a brand is in secular decline. If you ask your marketers to continue to offer the brand to customers, they should be measured on revenues over baseline; if the baseline is declining and the marketers are successful in slowing down the decline, then they should be recognized for it.)

In addition to net revenue growth or growth over baseline revenue, a third outcome measure for marketing should be the increase in gross margin achieved by improved pricing and mix. This should be expressed in revenue terms rather than percentage terms.

So, at the end of the year, marketing is measured by the increase in net top-line revenue and gross margin dollars. That's another way of saying: brand equity is money. Notice that we haven't focused on market share as an outcome, for many reasons. First, you can't take market share to the bank, so it's not truly an outcome. Second, the achievement of share is not truly in the marketer's hands; there are a lot of exogenous variables that are beyond the control of the marketing department. Third, share is often achieved by sacrificing unit price and gross margin (i.e., “buying share of market” via deep discounting); this is fatal to brand building and the opposite of what marketing should be trying to achieve. Fourth, share is an outmoded concept in the era of domain strategy.

The Metrics Framework

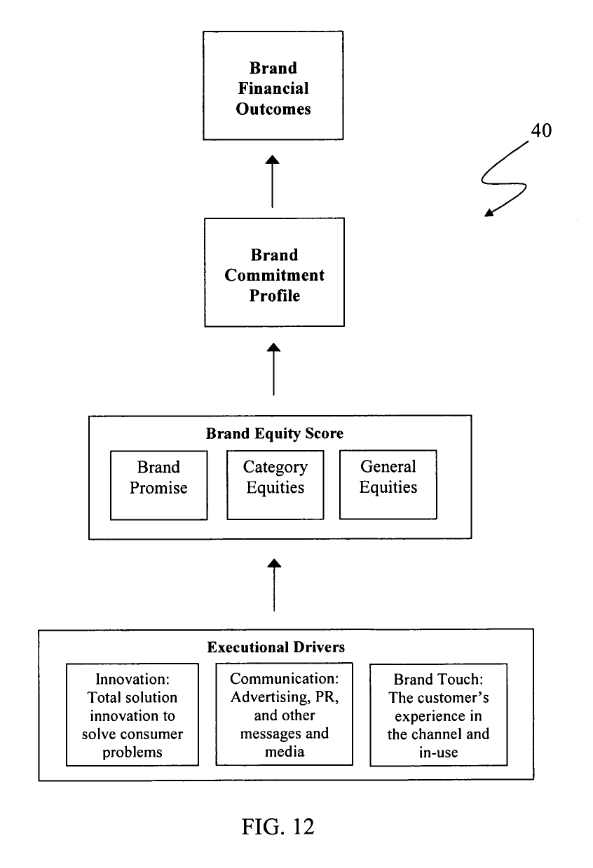

By a framework, we mean a structured concept of how the brand-building process works. This provides both a common understanding throughout the company, and a shared acceptance of what are the right metrics for the framework. Financial outcomes are driven by the strength of brand equity. Brand equity is driven by three major influences: innovation, communication, and brand touch. Each of these drivers should have its own metrics. A brand equity building model should be able to allocate spending between these three major groups of activities in proportion to their measured contribution to building brand equity. Agent-based modeling is capable of delivering this level of understanding. FIG. 12 illustrates a brand equity monitor framework 40.

You will also need an intermediate model between the brand equity score and the measure of financial outcomes that you select. When you walk into the CFO's office and declare that the brand equity score you have devised is a direct driver of top-line revenue growth and gross margin, your CFO is going to pause; his/her training doesn't allow him/her to understand the direct nature of that relationship. He/She needs the help of an intermediate construct, which we call the brand commitment profile. It's the metric that captures the idea of more customers buying more of your brand's offerings at more favorable prices.

The brand commitment profile is the metric for the most simple yet profound question in marketing: are my financial outcomes better if I maintain loyalty with my current customers or if I spend my funds on attracting new customers? A preponderance of analytical evidence points to the fact that loyal customers are the most profitable. (To cite just one example, a well-known 1990 Harvard Business Review article by Frederick Reichheld and Earl Sasser indicated that “companies can boost profits by almost 100% by retaining just 5% more of their customers.”)

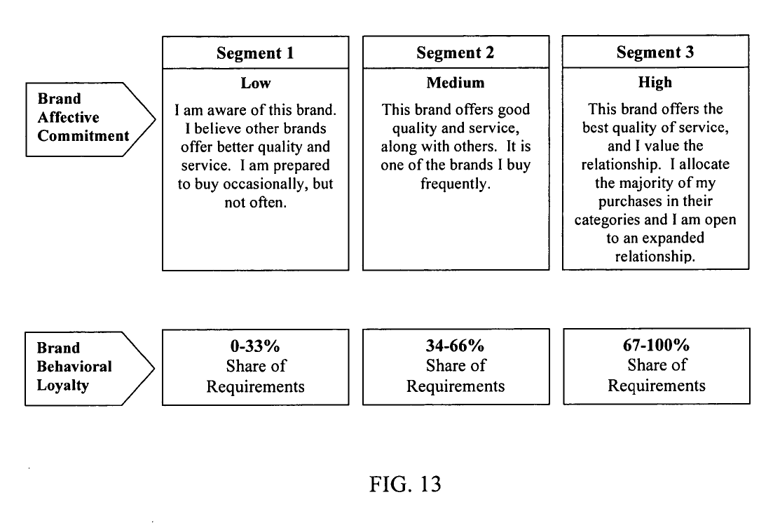

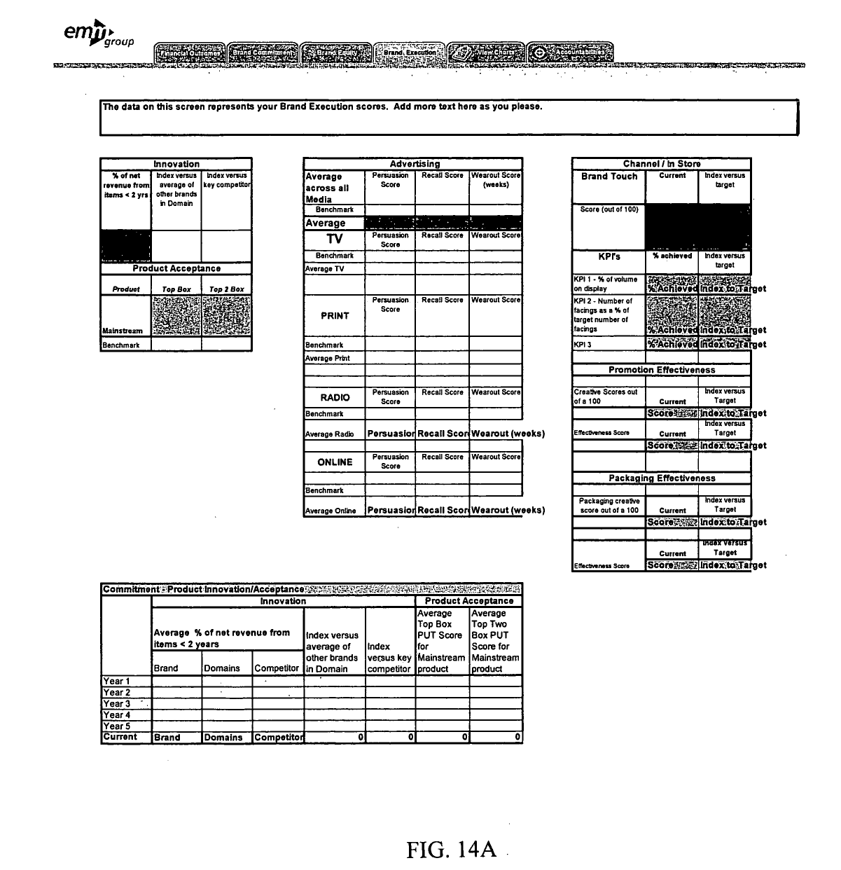

But there are times in a brand's life when it must emphasize the acquisition of those customers rather than their retention. The brand commitment profile is built on the following propositions. First, Attitude drives (precedes) behavior. Therefore we must first build positive attitudes to the brand. We call this affective commitment—customers love and trust the brand so much that they will buy it at every opportunity, pay more for it (e.g., by not seeking out the deepest of discounts or the lowest cost channel), and give favorable consideration to every new product the brand offers. Second, the resultant behavior is loyalty, defined as share of requirements—of all the dollars the customer spends in the target category, the loyal customer allocates all or most of them to your brand. FIG. 13 illustrates a brand commitment profile.

So now our metrics framework is complete: Measure outcomes: top-line revenue growth and gross margin; The driver of these outcomes is the brand commitment profile; how many customers are in the low-, medium-, and high-affective commitment segments and what percentage share of their requirements your brand achieves; the driver of affective commitment is brand equity, expressed as a brand equity score; and the drivers of the brand equity score are the marketing programs in the three major “boxes” of innovation, communications, and brand touch.

Measures

Top-Line Revenue Growth and Gross Margin

These measures come directly from your internal reporting systems. Data integration can bring them directly to the marketer's desktop in a dashboard that monitors brand performance.

Affective Commitment or Brand Attitude

This measure comes from survey data. It is a lot different from customer satisfaction, which is merely a snapshot in time of how the customer feels today. It captures the idea of both historical experience and future commitment. The question can be captured as brand trust or as a five-point scale question from “I would never consider this brand” to “I am totally committed to this brand and expect both to stay loyal to it and to accept new products and innovations it offers.”

Share of Requirements

This measure requires some computation. First, define requirements. This is the total amount that the customer spends in the market space you are targeting. Most industries have a third-party data source for total market size, and some kind of panel data for expenditure by customer type. The pharmaceutical industry in the United States can track prescription units by drug type by doctor. The health care industry can track total health care spending by category by hospital or hospital group. In consumer goods, ACNielsen has a panel of households that track their total expenditures in a number of categories and this can be projected to the United States as a whole.

Second, measure your share of requirements. This is the expenditure of the customer or customer segment on your products or services in the categories or market spaces that make up the defined “requirements.” These data can come from your internal sources or from a third-party measurement company.

Brand Equity Score

This is a survey-based metric. You should measure three items: (1) Brand equity ownership (the one promise you want to stand for); (2) Category drivers (the elements of acceptance on which it is necessary for your brand to qualify to be considered by the customer, and on which it is necessary to win to be preferred by the customer); and (3) General drivers of brand equity (such as differentiation, relevance, esteem, and knowledge). Develop a score out of 100 for each one and add the three together to achieve a single brand equity score.

The Executional Driver Measures

Innovation

There are two relevant measures of innovation: amount of innovation and quality of innovation. You will have to ascertain the right combination of quantity (“news”) and quality (“breakthrough”) over time. Quantity of innovation can be measured by the percentage of revenue your brand delivers via items or offerings that were not in the market in the previous period. You should benchmark this against competition (do you have more or less innovation revenue than competition?) and the category as a whole. You should also benchmark it against customer expectations, with a survey question such as “Which brand is the best at bringing you new ideas and solutions?”

Quality of innovation is measured strictly in terms of customer acceptance. This can be done at the premarket stage, trial stage, or loyalty stage. It should be measured in the premarket stage; a customer acceptance measure is usually defined as the score for “definitely or probably would buy.” These are often referred to as “top two box scores” and should total 75 percent for a product that will be successful in the marketplace. The right innovation metric would be the number of concepts in the pipeline with top two box scores of 75 percent or more.

At the in-market stage, the measure is the customer acceptance of the new product or service, which is composed of trial (what percentage of target customers tried the new offering) and satisfaction after usage (either reported satisfaction or intent to repurchase).

Communication

Measures of communication should focus on success in getting the brand message across to customers. (The long-term effect of the message is captured in the brand equity score.) The typical measures are recall, persuasion, and wear out. Recall (percentage of audience remembering the message) measures the impact of your messages. Persuasion (percentage of audience expressing the desired attitude) measures the effectiveness in achieving the goal of attitude change or reinforcement. And wear out measures the decay in recall and persuasion that occurs with overexposure or excessive repetition.

For specialized elements of the communications plan such as direct mail, promotion, PR, e-marketing, and others, it may be necessary to devise tailored measures. However, the overall metrics of recall (was the message received), persuasion (was the message effective), and wear out (is the message still welcome) continue to be primary. For some promotion activities, you may wish to measure action—such as click through for web-delivered offers, or redemption for coupons and rebates, or attendance at sponsored events and trade shows. But, in the end, these are intermediate measures. What you truly aim for in communications is recall, persuasion, and continued openness to the message.

Brand Touch

Brand equity is built via everything the customer sees, hears, and experiences. Brand touch is the experiential component. It includes the touches in the store or other retail outlet or office, at the call center, or on the Web. It includes packaging, merchandising, and sampling (such as encountering a cosmetics representative in the store, salon, or in the home or workplace). It includes the direct sales call and presentation in business-to-business, and doctor's office “detailing” visits in the pharmaceuticals industry. And it includes the product or service in use. All of these brand touches can add to or subtract from a customer's perception of brand equity, and build or destroy the customer's affective commitment. It is important to measure these elements of brand touch and to create an overall measure of whether your brand touch contributes a positive or negative influence on brand equity and financial outcomes. The right measure is an experiential one: a survey question that asks whether the recipient of the brand touch took away a positive or negative feeling.

The Brand Equity Monitor

This metrics framework can be viewed in its totality in a Brand Equity Monitor. This can be a digital dashboard or a scorecard presented on paper. It is composed of the financial outcomes, the brand commitment profile, the brand equity score, and the executional driver measures.

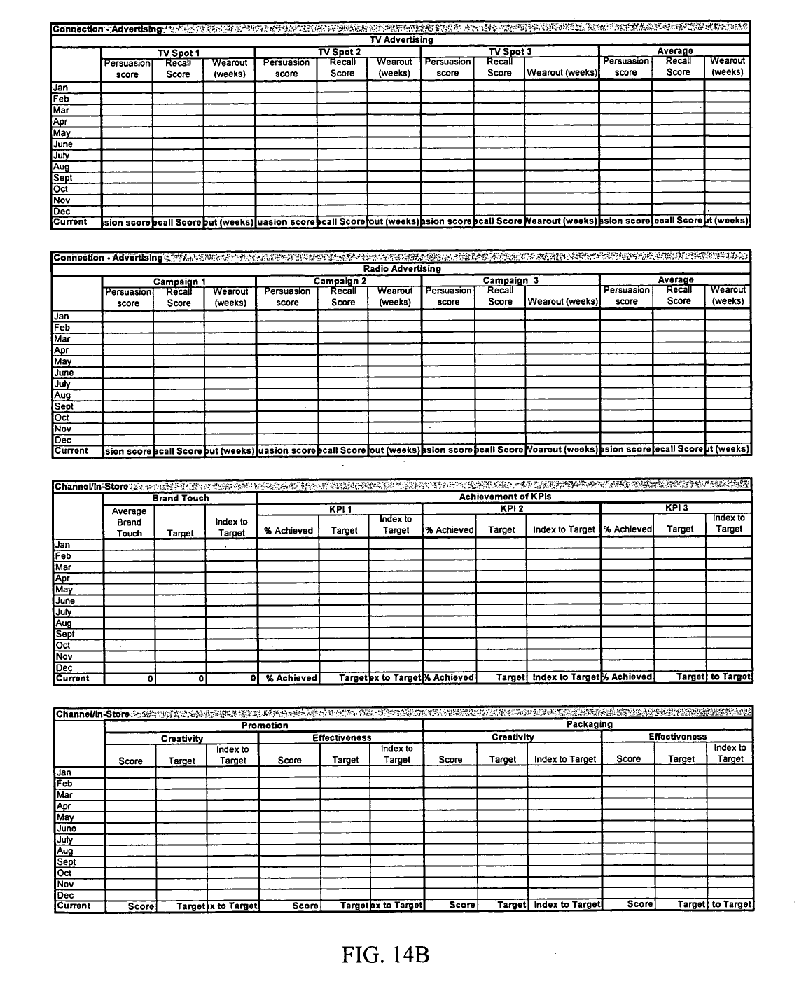

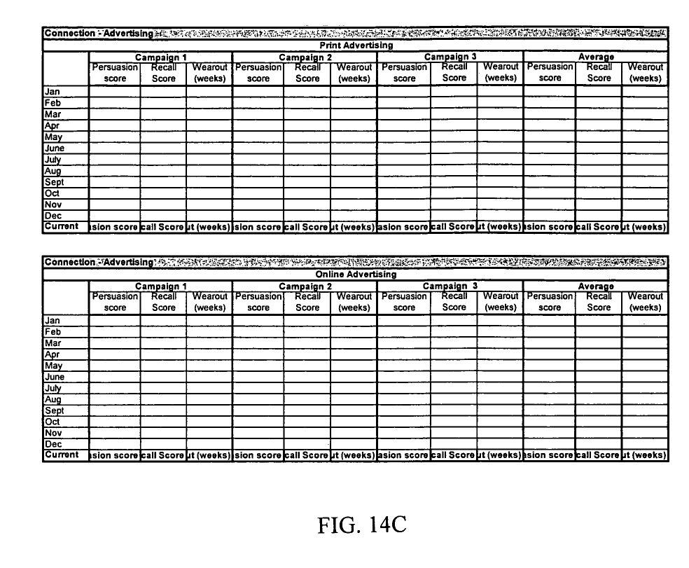

The Brand Equity Monitor helps measure brand equity. The measures include: the link between Brand Equity scores and the brand's financial performance; and the link between Brand Equity scores and execution excellence. The Brand Equity Monitor models the relationship between Brand Equity scores and the brand's financial performance: the brand's financial performance improves when Brand Equity scores increase. This relationship can be captured in an algorithm or co-efficient to predict how much financial performance can improve as a result of a given increase in Brand Equity scores. Further, the Brand Equity Monitor models the relationship between execution excellence and Brand Equity Scores so that resources can be allocated superbly to the right mix of marketing inputs (such as innovation, advertising, promotion, in-store presence and others) and a high return on marketing investments can be achieved. FIGS. 14A, B and C illustrate a brand equity monitor and interface guide.

The Brand Equity Monitor is a set of metrics that: links financial outcomes with Brand Equity scores; and identifies the Brand Equity execution drivers. The purpose of brand building is to drive the financial performance of the brand and consequently, the company. The financial measures to drive are:

Return on Invested Capital (ROIC): This is the highest-level financial target. It may be expressed as Economic Value Added (EVA) or Brand Value Added (BVA). Brands contribute to this measure by using the company's capital to achieve high growth rates in top-line revenue and to enhance Gross Margins.

Net Sales Revenue: This measure is what successful brand building drives most directly. Sales revenues are grown by increasing consumer purchases through trial, increased usage and increased loyalty. Net sales revenue is sales after deductions to the trade. This measures the results from brand building success in: Increasing the number of units purchased by consumers; Achieving premium pricing; Managing the share of value allocated to the retail trade and channel partners.

Brand Gross Margin: In addition to Net Sales Revenue, Brands also seek to improve their Gross Profit Margins. This is an indication of the value delivered to the consumer, which should be improved continuously. The Brand Gross Margin should fund potential future growth through reinvestment in innovation and communications to strengthen Brand Equity in future periods.

Market Share. Market Share is not a financial measure but it is a leading indicator of market performance in three ways: (1) It is a proxy for the attitude of consumers to the brand offering—a positive attitude is usually associated with positive market share trends; (3) It is a measure of competitive performance—building market share is usually a sign of beating competition, and vice versa.; and (3) It is a balancing measure—if Gross Margin is driven too aggressively, the brand might lose market share by overshooting on premium pricing versus value and if market share is driven too aggressively, it may erode Gross Margins via discounting.

Brand Equity is measured with three metrics: Brand Promise Ownership; Category-specific Equities; General Equities, as described below.

Brand Promise Ownership: Each brand must define the single differentiating equity it stands for, more than any other, in the minds of consumers. This equity must represent the highest attainable level on the consumer's Hierarchy of Needs for which the brand can deliver. Since it is the top level of the consumer Hierarchy of Needs—an end rather than a means—it is an emotional benefit which makes the consumer feel good, confident, happy, fulfilled, self-actualized, etc. in some way that is directly linked to the brand.

Category-specific Equities: Brand Equity ownership is unique to one brand. The second area of Brand Equity in consumers' minds is specific to the category in which the brand competes and applies to all brands in the category. Category-specific equities encompass both emotional and functional benefit areas. The category-specific equities are best confined to the top six equities that are identified in the brand tracking study. A brand is performing well on category-specific equities if it beats competition on all the equities. A brand can be performing well if it beats competition on the category-specific equities that are most important to its target consumer group, even if it loses on some that are more important to the competitor's target consumer group. A brand must take specific action if it is losing on one or more category-specific equities that are deemed most important by its target consumers.

General Equities: The third area of Brand Equity is the general equities that indicate the brand strength and are a common measure for all brands. A single study is used across all brands and all markets to monitor this measure of Brand Equity. The general equities are shown in Table 4:

TABLE 4
General equities

| | |
|---|---|
| Differentiation | Consumers feel that the brand is |
| | different and better than others in its |
| | category. |
| Relevance | The brand understands consumer needs |
| | and meets them. “It is a brand for me.” |
| Esteem | The brand is well respected and keeps |
| | its promise. |
| Knowledge | Consumers are aware of the brand and |
| | its attributes. |
| Value | Consumers perceive the brand as |
| | offering good value for the price paid. |
| Loyalty Attitude | Consumers qualitatively express their |
| | loyalty to the brand. |

The list is narrowed to six measures and a composite score is created out of 100. This allows the brands to keep track of its score on the following multiple levels: Absolute score at a point in time in a given market; Trend: up, down or stable; Compared to same brand in other countries; Compared to other company brands; Compared to competitors.

At its third level, the Brand Equity Monitor can help identify those areas of brand execution that are most influential in raising Brand Equity scores. This will, in turn, improve financial performance. Execution drivers are discussed elsewhere herein.

In the framework proposed herein, the viewpoint starts at the top—top-line revenue growth and gross margin at the brand level. It then works downward to shed light on each sequential driver: the brand commitment profile drives financial outcomes; brand equity scores drive brand commitment; and the executional drivers of innovation, communication, and brand touch drive brand equity scores. Therefore, as you work your way in metrics from the top down, your first stop should be trying to understand the relative effects of the big “buckets” of innovation, communications, and brand touch, and to allocate resources between them accordingly.

The next stop is market mix modeling at the initiative level (rather than evaluations of individual programs). Market mix modeling is analysis of which groups or types of activity are contributing most to brand equity and brand revenue growth. Market mix modeling has emerged as a credible way of estimating the relative efficiency of the major marketing expenditure choices. This welcome advance in marketing science can direct you toward the long-term goal of an “optimized” marketing budget. It does not help you to make choices between individual programs (such as a product promotion), but it can guide you toward a definition of what is the optimum mix of activities (between promotion, advertising, price reductions, and PR, for example).

Market mix modeling is a product of regression analysis, often multivariate. That means it requires historical time series data of sufficient duration to determine a pattern of cause and effect, and sufficient density to be able to isolate the effect of different types of marketing activity. The modelers often call the output the “due to” effect—how much of a revenue increase was due to activity type A (such as advertising) versus activity type B (such as sales promotion). Given the availability of data, market mix modeling can be quite discriminatory into how far it can break down the relative influence of different marketing activity—often into 10 or more discrete types.

But by its nature, market mix modeling is backward-looking, approximate, and limited by available time series data. A more sensitive and potentially accurate way to model the optimum marketing mix is agent-based modeling. Because it is a simulation, agent-based modeling can accept many more kinds of data than a market mix model—including survey data, nonlinear data, and even expert opinion. It can also simulate outcomes that market mix modeling could never contemplate, such as the “buzz” of word-of-mouth that can often carry a new product to early success, or the effect of distribution on awareness. As we mention elsewhere, leading marketers in many industries are pioneering in building experience with this tool, and you should become knowledgeable about it quickly.

Only after market mix modeling or simulation is complete do we recommend the analysis of individual programs such as advertising campaigns, direct mail campaigns, and trade shows. For each one you must determine the notional metric and then make sure the data gathering methodology is in place before the activity starts. It is extremely difficult, if not impossible, to isolate data from one activity versus another, so you must decide how you will tackle this problem. You might compare activity this year versus last year using the “all other things remaining equal” principle. Or you may be able to hold out one region or one time period that did not receive the activity. Have your methodology, data, and business case argument in hand before you launch the measurement. At minimum, it is a sound philosophy to “measure everything.” With this discipline, you can only get better over time.

Top-line revenue growth and gross margin are measures of effectiveness. These are the outcomes for which marketers strive and against which the function and the investment should be measured. Not much good can happen in a company that doesn't have top-line revenue growth, and that's what marketers concentrate on. The same is true for brand commitment (both attitudinal and behavioral). These are measures of the effectiveness of marketing in creating outcomes. Similarly with a growing brand equity score, quality and quantity of innovation, and brand touch. All are effectiveness measures. Return on investment can be defined as the increase in top-line revenue achieved per dollar of marketing expenditure.

Our point is twofold. First, concentrate on effectiveness. Second, apply the principle of top down, not bottom up, to efficiency measures. Thus, the first efficiency measure is total increase in top-line revenue over baseline, divided by total cost of marketing. This simple “one number” approach normalizes the return on all expenditures across the enterprise landscape. By focusing on ROI, management can choose priorities among expenditures as diverse as a new manufacturing line, a new piece of CRM software, a new sales team at a key account, or an increment in allocation of dollars to the marketing function. It can be easily accepted as a “fair” guideline, because everyone intuitively understands how the ROI yardstick enhances the overall efficiency of the enterprise

Another top-level efficiency measure utilizes the brand commitment profile and measures the cost of moving customers up the attitudinal commitment continuum divided by the resultant revenue and profit increase from moving them up the behavioral benefit continuum.

At the level of each of the major executional drivers, a similar ROI analysis can be performed.: The revenue contribution of innovation divided by the cost of innovation; The revenue contribution of communication divided by the cost of communication; The revenue contribution of brand touch divided by the cost of brand touch. In each case the revenue contribution to the total can be derived via market mix modeling. Go beyond this level (i.e., “lower” in terms of granular detail) only when all the measures listed in this section are in place, and when you are confident that the energy you expend on the analytical effort will return an equal or higher benefit. You might call that an ROI on analytic effort.

In summary, good management requires good metrics. A “metric” is a performance measure that top management should review. In the case of marketing, these are financial outcomes and their key determinants: brand commitment, brand equity, and their major drivers (innovation, communication, and brand touch). Upward movements in these numbers are the measures of the effectiveness of marketing. The ultimate efficiency metric is ROI. However, its highest benefit is realized at the overall level (ROI on total marketing expenditures), and you should be sure to have that capability in place before moving to focus on the marketing mix level and, lastly, the individual activity level.

Marketing Implementation and the Marketing Portal

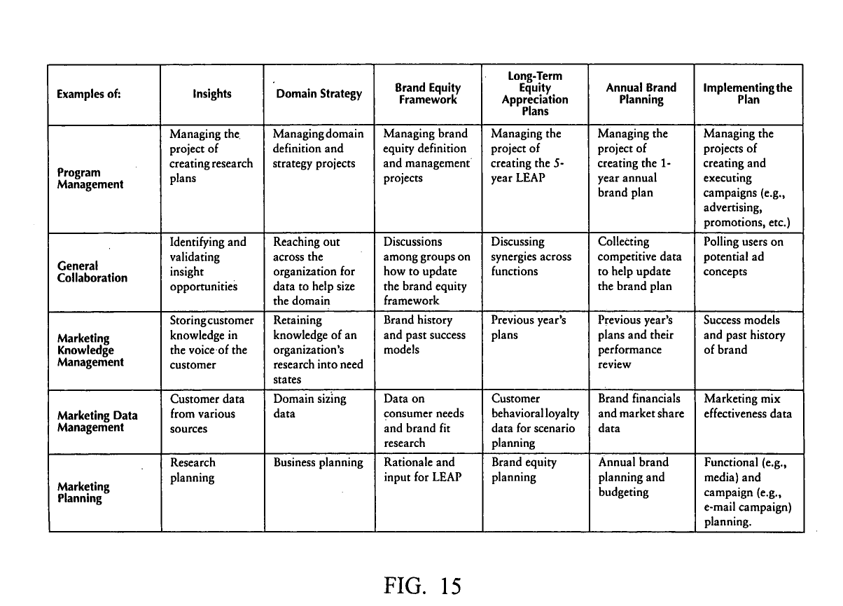

Marketing processes are very diverse in their scope and requirements. While strategic processes such as domain strategy and brand equity management usually involve a limited number of fairly senior managers, executing advertising, promotions, and event marketing involves a larger team, including personnel from agencies and vendors. You do not need to create separate applications, however, for each of these processes. As shown in FIG. 15, the five most common categories of tasks that are used repeatedly in each of these processes are:

Program management: defining, launching, and managing marketing programs and projects;

General collaboration: enabling knowledge sharing and topical collaboration among teams outside the context of a project;

Marketing knowledge management: collecting, sharing, and retaining marketing knowledge including consumer knowledge, success models, brand histories, and other assets for reference and reuse;

Marketing data management: integrating data from internal company and external sources and providing analytical tools for processing that data; and

Marketing planning: developing, approving, and tracking plans, whether at an overall brand plan level or at an individual campaign level.

The marketing portal brings together all these required functionalities to provide a consistent and smooth user experience. This usually involves the use of an enterprise portal solution that can seamlessly reach into many applications and present the data in a consistent user interface. The portal is the single access point to knowledge, data, best practices, and automated processes. It is the technological realization of enterprise marketing management. The marketing portal becomes the marketer's desktop. It brings all the data, tools, and information to marketers that they require to do their job; Is an enterprise software solution to support the end-to-end marketing process framework; and Is highly configurable, to adapt its look and feel for the different divisions and brands within an organization.

How the marketing portal meets the functional requirements is described in the following.

Program Management

Marketers do most of their work in project teams. Whether it is a 24-month new product development project or a 6-week promotional project involving a free-standing insert (FSI) in Sunday newspapers, these projects have many similarities in the way they are defined, launched, managed, and closed. Marketers need a collaborative platform to plan, launch, manage, and track all their marketing programs such that all users have access to the project status and are able to easily share project files and information. This helps in managing highly complex marketing processes that involve participants from across functions and organizations. The broad requirements of marketers in this area include:
(1) Providing an easy guided path to completing the various steps required to create a project;
(2) Accessing best-practice-based, corporate-prescribed, ready-made projects with steps for the creation, review, distribution, and tracking of typical projects;
(3) haring a common platform among all participants for tracking the project activities and progress;
(4) Accessing contextually relevant best practices for doing each task of the project;
(5) Using an automated approvals system for delivering approval requests and tracking all approvals in one place;
(6) Tracking the history of events in a project for later analysis;
(7) Collaborating effectively and efficiently with other team members without having to sit through long status update meetings; and
(8) Archiving closed projects in a common archive from which they can be retrieved to and modified for further reuse.

The technology tools that best meet these requirements are collaborative project management tools. It should be noted that generic workflow tools usually do not meet these requirements.

General Collaboration

Marketing processes usually involve people from various internal functions across an organization, and also agencies and vendors working together to produce the required deliverables. Technology can facilitate virtually all of this collaboration. The key requirements in this area are: (1) File-based collaboration; (2) Selectively sharing files in a central repository; (3) Soliciting inputs; (4) Maintaining version control; (5) Searching for files within the repository; (6) Discussions across a geographically dispersed team; (7) Remote sharing of files in real time; (8) Project-related work is integrated with the e-mail system; (9) Key system tasks being performed offline; (10) Opinions being sought from within a certain group; and (11) General collaboration features like file sharing, document management systems, discussion boards, polling tools, and real-time meeting capabilities can meet these requirements.

Marketing Knowledge Management

We have identified that one of the biggest issues facing marketers is the lack of historical knowledge. Effective marketing requires easy access to knowledge of consumers, channels, competitors, and brand history. Such knowledge is invaluable in avoiding past mistakes and for reusing existing knowledge in various parts of the organization. Marketers are often frustrated by how difficult—if not impossible—it is for them to find the right information. The key requirements in this area are that it:
(1) Acts as a single repository for current knowledge and expertise: case studies, success models, consumer knowledge, processes, templates, checklists, models, project templates, examples, etc;
(2) Creates hierarchies of information based on taxonomy and offers a drill-down capability to users in one part of the information hierarchy;
(3) Provides categorization and search capabilities;
(4) Manages rich media assets;
(5) Stores and serves web-based calculators and other such tools;
(6) Sets access rights at the file level to provide access control;
(7) Determines linked files based on metadata similarity;
(8) Provides web-based access to users from across all parts of the organization.

Management-based knowledge management software tools are usually able to meet these requirements. Handling rich media assets, however, usually requires the use of digital asset management solutions.

Marketing Data Management

Marketers need data from disparate internal and external sources and a set of analytical tools to make fact-based decisions. The important requirements in this area are:
(1) Integration capability to interface with different types of data sources;
(2) Data extraction from relevant data sources, both external (e.g., syndicated data, advertising tracking studies) and internal (e.g., ERP, CRM);
(3) Cleaning and transforming data-normalizing, removing broken/incomplete records, etc;
(4) Loading data into a relational database in a data mart designed and optimized for marketing analysis, such as market mix modeling and scenarios-based planning;
(5) Marketing analytics;
(6) Market mix modeling and other causal modeling;
(7) Forecasting and time-series modeling;
(8) Agent-based modeling and other simulations;
(9) Brand equity monitoring;
(10) Data management capabilities, including availability of;
(11) Standard queries;
(12) OLAP type capability to slice and dice the data;
(13) Report generation capability;
(14) Dashboard capability to draw and analyze data and present it in the form of key metrics to managers with multiple-level drill- down capability in increasing levels of detail.

The typical IT tools required to meet these requirements are an ETL tool (for extraction, transformation, and loading), a reporting engine, dashboarding capabilities, and an analytical engine that allows both time-series and causal modeling.

Marketing Planning

Marketers need a tool to budget and plan their various programs from new product development and annual plans to advertising, promotion, and media initiatives. The capabilities required in this area include:
(1) Collaborative campaign planning;
(2) Best practice guidance on setting objectives;
(3) Modeling capability to support objective setting such as reach/frequency objectives for media campaigns;
(4) Preparing detailed budgets, using flowcharting tools for some campaign types;
(5) Integration capability to interface with back-end financial system for budgeting;
(6) Forecasting plan results on the basis of historical data and time-series modeling;
(7) Forecasting planning costs on the basis of historical costs and latest market dynamics;
(8) Approving plans through a workflow process;
(9) Tracking the plan performance and reporting;
(10) Closed-loop financing;
(11) Archiving of plans for reuse.

A campaign management tool, which includes campaign and initiative planning and campaign management capabilities, could meet the requirements highlighted above.

Enterprise marketing management combines process mapping, metrics, and technology to make the entire complex system of end-to-end marketing processes operational in the fast-paced, ever-changing workplace. The present invention provides a technology-enabled solution, when built with content and real work process purposefully integrated, in an easy-to-use interface, that can enhance the creativity and leverage the productivity of every employee in the company. It can inspire people to innovate and to use technology to unleash creativity, increase effectiveness and efficiency, and fulfill people's desires to do great marketing to expand growth.

The Marketing Knowledge Center

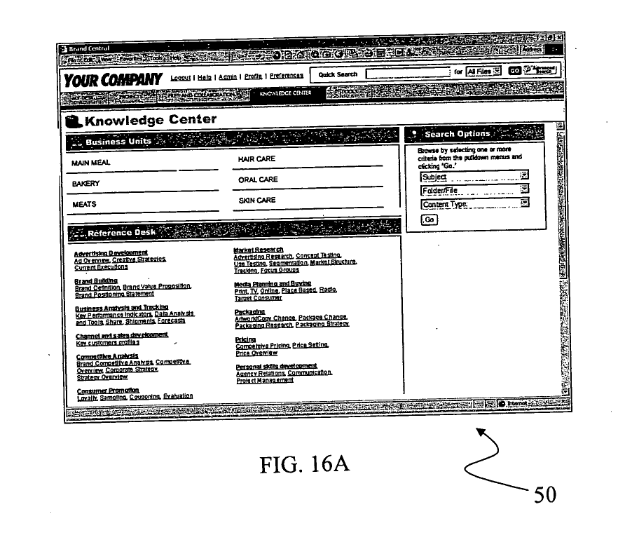

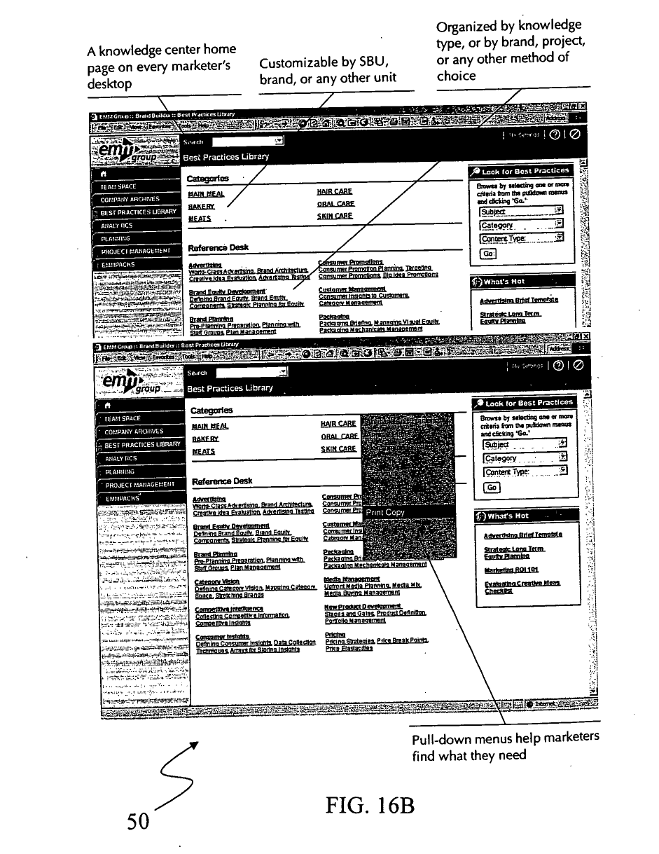

The marketing knowledge center (MKC) is the first step on the road to building a full-scale Marketing Portal. The MKC provides the organization with an immediate competitive advantage: speed of learning. Studies suggest that the company that achieves first mover advantage gets about 60 percent of the share of a new market. Accelerating the speed at which knowledge and information is shared within an organization allows for the benefits of past learning to be applied and costly mistakes avoided. FIGS. 16A and 16B are schematic illustrations of various embodiments and implementations of marketing knowledge center interfaces 50.

The advantage also applies at the individual and team levels. The ability of a marketer to save time by understanding what has worked in other areas and why it has worked also gives that person the advantage in speed. This is significant, because speed enables marketers to get through the routine tasks quickly and frees them and their teams to apply themselves to more creative, value added activities. In the mission to enhance the speed of learning within companies, the MKC contributes by taking marketers quickly up the learning curve. Another advantage of the MKC is that the memory is shifted from individuals to the corporation. So you create a “corporate memory.” You give your people the ability to learn on the job, get all key data quickly, and assimilate themselves in a new brand assignment very quickly.

An MKC is a comprehensive corporate digital library containing all of the data necessary for your marketing department to function at peak efficiency and effectiveness. It's a collection of all your internal best practices and actions that you know have worked in the past. An MKC embraces best practices in marketing processes, data, analytics, and modeling. It also includes best practices content (guides, tips, and templates) to assist in the tasks of marketing, tools to actually implement those marketing tasks, and metrics to monitor the effectiveness of marketing activity. Because the typical marketing knowledge center is deployed on a company's intranet, the data is available to all approved employees 24/7.

Creating an intuitively navigable MKC is the quickest and easiest way to begin your company's journey toward marketing excellence because it shifts knowledge from the erasable “write and rewrite” memory of an ever-changing human employee base to a permanent, growing, and synergistic corporate memory. Equally important, a marketing knowledge center is a continuously visible symbol to your marketing personnel that you are serious about optimizing their output.

Few companies have a comprehensive shared knowledge base for marketing. The need for this capability might lead to small bands of professionals planning to create their own electronic library for their brand, region, or functional area. The problem with such a narrow approach is obvious . . . no common standard across the company, no company-approved “best practices,” no procedure for what's in or out, and no links to similar libraries outside the immediate area.

The practical results of this almost universal condition are as follows: (1) Projects move slowly because a common process path does not exist; (2) “The wheel” must be rediscovered, and mistakes repeated frequently, because corporate knowledge about what works and what does not has vanished with the relocation or resignation of a key employee; (3) New initiatives fail or succeed randomly because no proven repeatable development process is captured in an MKC. Different divisions or brands follow different recipes for new product development; (4) Investment dollars generate unreliable returns because what has worked in the past in a similar situation is lost to those new to the business; and (5) Human capital is squandered by needless searches, meetings, and debates.

An MKC enables everyone in the company to share the company's best thinking about its brands and business. It makes best practices available so that employees new to the company or the brand can come up the learning curve rapidly. The MKC is even more important for global companies. Many regions outside the United States and Western Europe do not have good information and metrics. It provides easy access to the programs that have worked in other areas of the organization, and a common understanding about customers and competitors.

By creating a comprehensive, contemporary MKC, companies can raise the effectiveness levels of their marketing processes and marketing investments. This effectiveness dividend is manifested in several tangible ways. An MKC results in a greater percentage of successful initiatives, because marketers maintain a knowledge base of success models. A marketing knowledge center also raises speed and agility—including faster time to market—because marketers collaborate around known processes and knowledge. Everyone in the marketing department learns faster, and in the long term this creates a competitive advantage in speed to market.

The research will be shared in an MKC throughout the company and everyone in the organization will know what they did not know previously. This is important because in-store communications or brand touch is a critical area. Using this data, a company will now know more about a key area that affects their brand equities and the health of their business, as well as previously unknown facets of their customers' preferences. The company is poised to respond quickly to the requirements of their customers.

An MKC has certain other advantages that are less obvious but equally important. Specifically, an MKC:
(1) Encourages the sharing of success models between countries at similar levels of consumer or retail development. It can prove disproportionately valuable for global companies with businesses in data-poor environments such as China, Asia, Eastern Europe, Africa, or Latin America. Good practices may establish itself in one country or one geographic region, but it seldom transfers to others. The MKC can transcend these barriers. An idea for the same class of trade in South Africa may also work in Korea. Where marketers lack customer data, the MKC can produce world-class perspective.
(2) Provides a continuous teaching and training presence. Today, the average marketer stays in a position for less than three years. While training dollars have been slashed, the MKC becomes a reliable source of short-term knowledge about the current business as well as the long-term collective wisdom of the company's best practices. The MKC is a repository of learning. It serves as a continuous training device.
(3) Identifies a clearer idea of what the company does not know. Too often, the corporation doesn't know what it doesn't know, and even more dangerously, thinks it knows things it doesn't. This is especially true today, since headcount reductions have often eliminated expert departments and individual “gurus,” who held the organizational memory in their heads. It isn't until a company has arrayed its data in a logical format and studied it that marketers realize more clearly and urgently what they don't know.

In short, an MKC is your company's customized marketing library. The center can be designed, constructed, and launched in a short period of time. It can run on existing technology and be made accessible from every marketer's desktop, as shown in FIGS. 16 and 17.

A “best practice” MKC contains several different types of data and functionality: (1) Current and past marketing plans by brand, category, or region; (2) Historical “gold documents” that represent the best company thinking on the broad panorama of marketing issues; (3) Approved marketing processes such as building brand equity, creating an annual plan, developing a media plan, and creating a major marketing event; (4) Current and historical data on key subprocesses such as advertising executions, media spending plans by day part, promotional response by promotion type, distribution channel data, and key account plans; (5) Important marketing articles from external experts; (6) Chat rooms to “ask the company expert”; (7) Access to marketing Internet sites external to the company; (8) Access to third-party marketing partners such as advertising agencies or media agencies; and (9) Samples of package designs and printed promotional materials.

Building a Marketing Knowledge Center

Create a team. Building an MKC requires multifunctional skills from the marketing function, from marketing research, from the IT department, and from external marketing partners who may contribute data or use the system.

Review the capabilities and requirements of your corporate intranet to ascertain its functional limits. Important concerns relate to capacity, search and retrieval speeds, document-management capabilities, UI flexibility, and scalability.

Decide on the desired functionality. A contemporary MKC will have certain basic functionalities including standard document-management characteristics, a keyword search function, metadata management, and access to external third-party marketing partner resources. An MKC may also have a chat room functionality that permits members of the marketing department to access recognized corporate experts or third- party experts on a regular basis for discussions of issues.

Create a taxonomy. Taxonomy is the way in which data is organized, such as the Dewey decimal system in a conventional library. There is no one right or wrong taxonomy. Because each company is different, one would normally expect data to be organized somewhat differently from company to company.

The most important taxonomic principles relate to the top levels of the organizing pyramid; does one organize around categories or brands or processes or geographies? Generally speaking, marketers prefer to organize around categories or brands at the highest level and then, beneath that, array data around specific tasks such as advertising development, media plan development, promotion, and so on. A typical simplified high-level organizing taxonomy for a marketing department includes: Advertising, Brand equity, Competition, Customer insights/research, Marcomm, Marketing plans, Media planning, Packaging, Pricing, Promotion, Channel marketing, Training.

By constructing an MKC, management takes the first step toward turning their marketing department into a “center of marketing excellence.” The MKC will establish the basis for information dissemination, knowledge sharing, teaching, training, and motivation that can turn the current employees into an army of marketing experts who are agile, productive, and use company scale to advantage.

The Loyalty Ladder

In another embodiment, the present invention provides a Loyalty Ladder (LL) that is a modeling tool that companies use to manage the profitable growth of their business. The model may be based on the key drivers of brand revenue growth and profitability: penetration and behavioral loyalty (the latter is also known as Share of Requirements or SOR). (See FIGS. 10A and 10B).

The model can be used to provide a snapshot of the brand's revenue generating pattern (the current profile, indicating what percentage of households fall into high, medium and low loyalty segments and the financial outcomes of that pattern). The model can then be used to perform “what-if” scenarios of various strategic options to grow the brand business. It can provide decision support in balancing trial versus loyalty strategies, and in making choices between targeting one selected group of consumers versus another.

With the appropriate data, the model can, potentially, be used to perform an ROI analysis on total marketing expenditures. It can also, with some limitations, point to relative ROI comparisons between different marketing tactics.

In one non-limiting example, the Loyalty Ladder may be designed and delivered at the level of a single brand in a single category, such as BRAND Diapers in the Diapers category. To develop a Loyalty Ladder for the total BRAND Brand (diapers plus wipes), we can develop an additional one for BRAND Wipes in the Baby Wipes category, and then identify a way to combine the two LL's in terms of share of requirements of “diapers plus wipes”.

In one embodiment, the scope of the Loyalty Ladder EMMPack includes the following features: 1) creating a Brand's Loyalty Ladder, with the opportunity to add more complex layers of data as expertise with the tool advances; 2) executing “what-if” scenarios via the Loyalty Ladder and viewing the impact on Revenues and Margin; 3) identifying and recording a Brand's LEAP imperatives and STEP initiatives ; 4) identifying the marketing mix elements that can help achieve the marketing initiative with the maximum ROI on the investment; and/or 5) tracking a brand's performance against the imperatives and initiatives.

As will be described in more detail below, the tools described herein can be made available to users in a variety of ways through various systems, networks, and configurations. The Loyalty Ladder, its software implementation, and related tools are themselves are not limited to any such system, network, or configuration but instead can be adopted by a user in ways that are deemed most appropriate by those users. An exemplary set of interfaces will be discussed below in order to provide an overview as to how marketing tools according to the invention may be used.

In one possible embodiment, when the user arrives at a computer terminal with the tool installed, the user is presented with a variety of brands and actions for each of those brands. The user is presented with a list of all tools available with hyperlinks to those tools. After a user selects a tool to work in, the user is taken to the document menu screen for that particular tool.

The computer or user terminal may be on a network that includes a marketing system that provides access to marketing tools to one or more users. The users may access the marketing system directly, such as on a stand-alone computer, or through a network. The system may additionally be coupled to, or interfaced with, one or more third parties. The users may use any suitable device for accessing the system including, but not limited to, personal computers, personal digital assistants (PDAs), mobile radio telephones, internet appliances, as well as other types of devices. While the system is preferably accessible through the Internet, it should be understood that in other embodiments of the invention, the system may reside in a stand-alone device such as a personal computer, within a network, such as a local area network (LAN) or wide area network (WAN), or accessible through other networks. As mentioned above, the invention can be implemented in different systems and networks.

The Loyalty Ladder according to the present invention may have the following outputs/features. It should be understood that the Loyalty Ladder is a tool that has a properties section that may contain descriptor information. It may include: Brand, Domain, Sector, Geography, Loyalty Ladder Managed by: and Last updated on.

The Four Groups:

In one embodiment, the Loyalty Ladder may be organized into four groups as listed below:

Group 1—Non-users (consumers identified as in the category but non-purchasers of subject brand in last 12 months);

Group 2—Consumers whose 0-33% Share of Requirements (standard units) are met by the brand;

Group 3—Consumers whose 34-66% Share of Requirements (standard units) are met by the brand;

Group 4—Consumers whose 67-100% Share of Requirements (standard units) are met by the brand.

These four groups represent break-point percentages of a standard unit of percentage share of requirements. Although described above in sets of percentages spanning approximately one-third, it is contemplated that other percentages may be utilized with more or fewer groups.

Views:

Once created, the Loyalty Ladder may be viewed in a variety of manners as discussed below.

Financial View

The ladder may be the financial information view. As a nonlimiting example, this main view of the Loyalty Ladder may be a graphical description of the four groups with the following financial information: 1) % of HHs who are users in the category; 2) Of these HH, % Heavy/Light using households (such that all data and calculations can be sliced on these two dimensions); 3) Total standard units purchased in last 12 months; 4) Total standard units of brand purchased in last 12 months; 5) Brand share of standard units purchased in last 12 months; 6) Total net revenue (all brands) resulting from purchases in last 12 months; 7) Total net revenue (subject brand) resulting from purchases in last 12 months; 8) Brand share of net revenue in last 12 months; 9) Total Brand Gross Margin (all brands) resulting from purchases in last 12 months (=Profit Pool); 10) Total brand Gross Margin (subject brand) resulting from purchases in last 12 months; and/or 11) Brand share of profit pool in last 12 months.

There might be detailed data used to calculate each of the above data elements (e.g. units per HH, net revenue per unit and net revenue per HH are the three data elements used to calculate Total Net Revenue for each group). The user should be able to access this supporting data also.

The Brand Equity View

Another view of the Loyalty Ladder will show the Brand Equity information. In one embodiment, this view will include the following data elements for each of the 4 groups:
The composite Brand Equity score out of 100;
Brand Equity Ownership—the Brand's score on the single most important equity driver that it desires to own and distance from key competitors;
Category-specific drivers—the Brand's score on the category-specific drivers;
General-equity drivers—the Brand's score on the general equity drivers of Differentiation, Relevance, Esteem, Knowledge, Value and Loyalty Attitude.
   The Marketing Mix View:

Another view of the Loyalty Ladder will show the Marketing Mix information. The Marketing mix view is used to capture the response effectiveness and efficiency of each marketing mix element. This includes for each of the market mix element of CP, Advertising, Trade, PR, packaging and price the following data elements:
$s of total annual brand marketing expenditure/HH required to keep it in the group
$s of total annual brand marketing expenditure/HH required to move it to the next group;
Net revenue /$ of input resulting from maintenance expenditure (keeping HH in the same group)
Net revenue /$ of input resulting from growth expenditure (moving the HH to next group);
Gross margin /$ of input resulting from maintenance expenditure (keeping HH in the same group);
Gross margin /$ of input resulting from growth expenditure (moving the HH to next group);
ROI % of total annual spending in keeping the HH in the same group;
ROI % of total annual spending in moving the HH to the next group;
Same set of data and calculations for each individual mix element.
   The Consumer View

Another view of the Loyalty Ladder will show the Consumer View information. This view allows the user to see the HH profile for each of the 4 groups and includes the following data elements (although other elements may also be included):
Demographic profile—Income, Lifestage, Profession of primary wage-earner, geography, family-size, ethnicity, home ownership, etc.
Attitudinal information—Interests, Opinions, memberships, preferences, etc.
Behavioral information—shopping behavior, consumption behavior, media consumption behavior, promotional behavior, etc.
   The Customer Channel View

Another view of the Loyalty Ladder will show the Customer Channel View information. This view allows the user to see the channel related information for each of the groups, including:
% of total HH purchase of all groceries made per channel;
% HH purchase of this category per channel;
% HH purchase of this brand per channel;
Purchase occasions/HH/year.
   LEAP Imperative View

Yet another view of the Loyalty Ladder will show the long term equity appreciation Plan (LEAP) Imperative View information. This view allows the user to see the LEAP related LL analysis.

As a nonlimiting example, it may include the following:
The Adopted LEAP Scenario which is a collection of the LEAP LL Strategies that the brand intends to address over the following LEAP horizon.
LEAP LL Strategies—these are the LL profile changes that the Brand team would like to effect over the 5 year LEAP horizon. An example of a LEAP LL strategy is “Move 7% HHs from Group 1 to Group 2”. These are strictly expressed in terms of changes in the LL profile. The collection of all the LEAP LL strategies constitutes the net change required in the LL profile over the 5 year period. The user should be able to see the financial impact of the net change in the LL profile caused by each of the LEAP LL Strategies as well as the total impact by the collection of the LL strategies. The financial impact will be in terms of revenue, gross margin and Brand share of profit pool.
LEAP Imperatives—LEAP Imperatives are statements of key actions/outcomes required to be taken by the brand over the 5 year period. Each Imperative is linked to one or more LEAP LL strategy. Each LEAP Imperative also has certain attributes (see section on Identifying LEAP Imperatives below). The user should also be able to see each attribute for the Imperative.
   STEP Initiative View

Another view of the Loyalty Ladder will show the STEP Initiative View information. This view allows the user to see the STEP related LL analysis. It includes the following:
The Adopted STEP Scenario which is a collection of the STEP LL Strategies that the brand intends to address over the following STEP horizon.
STEP LL Strategies—these are the LL profile changes that the Brand team would like to effect over the 1 year STEP horizon. Like the LEAP LL strategies, these too are strictly expressed in terms of changes in the LL profile. An example is “Move 5% HHs from Group 3 to Group 4”. The collection of all the STEP LL strategies constitutes the net change required in the LL profile over the 1 year period. The user should be able to see the financial impact of the net change in the LL profile caused by each of the STEP LL Strategies as well as the total impact by the collection of the LL strategies. The financial impact will be in terms of revenue, gross margin and Brand share of profit pool.
STEP Initiatives—STEP Initiatives are statements of key actions/outcomes required to be taken by the brand over the 1 year period. Each Initiative is linked to one or more STEP LL strategy and to one or more LEAP Imperative.

Each STEP Initiative also has certain attributes (see section on Identifying STEP Initiatives below). The user should also be able to see each attribute for the Initiative.

Data for the Loyalty Ladder

The loyalty ladder may be created through the use of a variety of data sources. The Loyalty Ladder may use the following discrete data sources: AC Nielsen's HH Panel data; Internal SAP data on—brand revenues, gross margins and marketing spends by function; Brand equity scores from Brand Tracking studies. Besides these, the Loyalty Ladder also contains unstructured data entered by the user for fields such as consumer insights, competitive analysis, etc.

Entering the Data:

In one embodiment of the present invention, there should be two mechanisms for entering data into the system:
Manually—where there are data entry templates with fields which can be manually entered.
Automatically—where the data is directly extracted with the data source at regular intervals or on demand.
The manual-entry of data will involve: a series of screens where the user is asked for data entry. Each view of Section 4.1 above will have its own series of screens that allow an administrator to enter data.
   Updating the Data:

In one embodiment of the present invention, the LL will be updated as and when new data is available. In manual entry mode, the user should be able to update the data fields and update the LL output. In automatic entry mode, the data will be synchronized with data source on a per-demand or on a pre-defined time period basis and the output updated accordingly.

Creating Scenarios

Scenario Creation

In one embodiment of the present invention, a scenario is created by a user to see the impact of LL strategies on the brand financials. This what-if scenario planning that changes the LL profile, helps the user determine the appropriate mix of strategies to meet the brand's financial commitments. The user can create a scenario through the following functionality:
A scenario consists of one or more strategies.
A strategy as defined above is a specific change in the LL profile.
The user first decides on whether s/he is creating a LEAP or a STEP scenario.
The user can give the scenario a name and a description. The user name, date, brand, sector and domain are also recorded.

Within a scenario, the user creates a strategy by deducting/adding a % to a particular group and then correspondingly subtracting/adding the equal % from adjoining group(s).

The user can label that strategy. Default names are Strategy 1,2, . . .n.

A user can have any number of strategies in a scenario.

For each strategy and for the overall scenario, the user can see the financial impact that it has in terms of increase (or decrease) of Brand Volume, Revenues and Gross Margin.

The user should have the choice of seeing the impact at anytime during the creation of the scenario and continue to refine the scenario till the desired financial impact is arrived at.

Once the user is done with the scenario creation s/he has the choice of: Erasing the scenario; adopting the scenario and all it's strategies; saving the Scenario; and /or business rules for scenario creation

In one embodiment of the present invention, the LL EmmPack will have an admin screen through which the administrator can enter and manage business rules.

Business rules can be created to be applicable at the following levels: Brand, Domain, Sector, Region and/or LL Group.

In one embodiment of the present invention, business rules can be made applicable for LEAP scenarios and/or STEP scenarios. A business rule is defined for each group by: the maximum limit; the minimum limit; the maximum increase possible through one strategy; the maximum increase possible across strategies in a scenario; the natural attrition rate from the group; and the maximum increase to the group sourced from a particular group.

Viewing Scenario Impact

In one embodiment of the present invention, the user can view the impact that the scenario has on the brand's financials—volume, revenue and margin. The user can also view the impact each of the strategies in the scenario individually have on the brand's financials. The user can also assign probabilities of success to each strategy and therefore see a probability-weighted impact on the financials of the brand. In another embodiment of the present invention, the user should also be able to see the impact of the scenario and its strategies in a bar chart graph which shows the volume, revenue and margin total and composition for the brand.

Saving Scenarios

Erasing the scenario: If the user decides to the erase the scenario, then the scenario with all its strategies is deleted.

Adopting the Scenario: If the user has decided to adopt the scenario, the strategies contained within it become the adopted strategies for the LEAP or STEP Plan (depending on whether the scenario was a LEAP or a STEP scenario).

Saving the scenario: the user can choose to save the scenario for further refinement at a later time. The saved scenario is saved as a WIP scenario with all the metadata given to it during creation. During creation the user is given the choice of creating a new scenario or working on a WIP scenario.

Identifying LEAP Imperatives

In another embodiment of the present invention, once a scenario is adopted as the LEAP scenario, the net change in LL profile caused by its strategies becomes the target that the LEAP plan has to deliver on. The user may then identify the Imperatives for the LEAP Plan. LEAP Imperatives are statements of key actions/outcomes required to be taken by the brand over the 5 year period.

In yet another embodiment of the present invention, each Imperative is linked to one or more LEAP LL strategy. Each LEAP Imperative may also have the following attributes: (1) A unique ID number; (2) Objectives—statements of measurable objectives, usually defined in terms of LL changes targeted by the Imperative; (3) Potential Initiatives—These are a bullet point list of potential initiatives that need to be undertaken in the 5 year period to deliver the Imperative objectives. Each potential initiative also has an estimated budget and timeline.

Besides these attributes of the Imperative, it also has fields of supporting information. These fields include but are not limited to: Consumer Insight/consumer data analysis, Competitive Analysis, Key Success Drivers, Assumptions, and/or Risks. The above may also be integrated with SAP or other software. In one embodiment of the present invention, the following are an input into the 5-year plan object within the MRM solution: the Imperatives and their associated attributes. The MRM solution may have an API that allows it to import Imperatives with their associated attributes into the system and assign them to a 5-year planning object.

Identifying STEP Initiatives

In another embodiment of the present invention, once a scenario is adopted as the STEP scenario, the net change in LL profile caused by its strategies will be adequate to meet the financial targets that the STEP plan has to deliver on. The user may then identify the Initiatives for the STEP Plan. STEP Initiatives are statements of key actions/outcomes required to be taken by the brand over the 1 year period or other time period. Each Initiative is linked to one or more STEP LL strategy and to one or more

LEAP Imperative.

Each STEP Initiative may also have, but is not limited to the following: 1) a unique ID number, 2) LL Marketing Objectives—statements of measurable objectives, usually defined in terms of LL changes targeted by the Initiative; 3) Integrated Marketing Strategy (IMS)—these are a bullet point list of strategy-level contributions that will be made by each of the marketing functions to deliver the Initiative's objectives; each element of the IMS also has an estimated budget and timeline; 4) budget for the initiative; 5) start date for the initiative; 6) finish date for the initiative; 7) Planned ROI; and 8) Priority. Besides these attributes of the Initiative, it also has fields of supporting information. These fields may include: Consumer Insight/consumer data analysis, Competitive Analysis; Key Success Drivers; Assumptions; and/or Risks.

Again, the above may be integrated with SAP or other software. The following may be an input into the Annual plan object within the MRM solution: The Initiatives and their associated attributes. The MRM solution will have an API that allows it to import Initiatives with their associated attributes into the system and assign them to a 1-year planning object.

Performance Tracking

Tracking LEAP Imperatives

In another embodiment of the present invention, the LEAP Imperative can be tracked annually with a date and progress made so far. The LL EmmPack allows the user to enter the results of the LEAP Imperatives. This includes but is not limited to: the achieved results against the Imperative objectives, the key learning from the imperative; and/or the future direction. Once a user has entered the results of the Imperative, s/he can complete the Imperative and archive it.

Tracking STEP Initiatives

The STEP Initiative can be tracked quarterly with a date and progress made so far. The LL EmmPack allows the user to enter the results of the STEP Initiatives. This includes: the achieved results against the Initiative objectives; the key learning from the initiative; key contributions from Marketing Functions; and/or the future direction. Once a user has entered the results, s/he can complete the Initiative and archive it.

Archive

As mentioned above, the user can also access an archive of the closed LEAP Imperatives and STEP initiatives from an Archive list. Each entry in the list may have: the Imperative/Initiative; its attributes that were filled up during set-up; its results; any notes or pointers to causal factors not intrinsically obvious from the foregoing data.

Alerts and Reports

The user can also subscribe to alerts in the LL profile. An alert is sent off when the LL profile data is updated. The user can set up an alert for: a particular group; minimum limit; maximum limit; % change +/−; brand share of profit pool. The user can also run reports on the LL. These include but are not limited: Imperative performance report−with target objectives and current status of each imperatives; initiative performance report-with target objectives and current status of each initiative; and LL profile report for a chosen time period - with start and end LL profiles and for each group % changes, maximum in period, minimum in period.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, may use some but not all of the views listed above.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for analyzing marketing functions, comprising:
a digital asset repository; and
an analytical tool that integrates internal and external data, wherein said analytical tool makes said internal and external data available for metrics tracking and analysis, and wherein said analytical tool communicates with said digital asset repository.

2. The system of claim 1, wherein said digital asset repository includes best practices content.

3. The system of claim 2, wherein said best practices content includes at least one of: marketing plans by brand, category or region; historical company marketing documents; data on marketing subprocesses; marketing articles; access to chat rooms; access to marketing Internet sites; access to third-party marketing partners; and samples of marketing materials.

4. The system of claim 1, further comprising:
an interface that provides a user with access to said digital asset repository and said analytical tool.

5. The system of claim 4, wherein said interface is accessible by multiple users.

6. The system of claim 4, wherein said interface is an intranet site.

7. The system of claim 1, wherein said internal and external data includes consumer insight data.

8. The system of claim 1, wherein said analytical tool generates at least one analysis report.

9. A method for formulating a growth strategy for a brand, comprising:
a domain strategy process that identifies at least one brand opportunity in a domain; and
a brand equity process that provides a long term equity appreciation plan to reach a target equity level for said at least one brand opportunity in said domain.

10. The method of claim 9, wherein said domain strategy process includes:
collecting and analyzing consumer information;
developing a hierarchy of needs based on said consumer information;
developing a domain map using said hierarchy of needs;
establishing a needs landscape using said domain map;
identifying at least one needs state and products and services corresponding to said at least one needs state; and
sizing said at least one needs state to identify said at least one brand opportunity.

11. The method of claim 10, wherein said consumer information is collected and analyzed using a voice-of-the-consumer tool.

12. The method of claim 9, wherein said brand equity process includes:
assessing a present position of said brand;
determining a future position of said brand in view of said at least one brand opportunity;
formulating a brand vision strategy for brand equity growth of said brand from said present position to said future position; and
developing said long term equity appreciation plan based on said brand vision strategy to reach said target equity level of said at least one brand opportunity.

13. The method of claim 12, wherein said formulating a brand vision strategy includes preparing a master creative brief as a tool for development of creative elements to reinforce said brand equity growth.

14. The method of claim 12, wherein said long term equity appreciation plan includes:
providing at least one imperative;
providing at least one initiative that implements said at least one imperative; and

15. The method of claim 14, further comprising:
tracking performance of the at least one imperative and the at least one initiative using at least one metric.

16. The method of claim 12, further comprising:
creating a loyalty ladder; and
performing a scenario analysis.

17. The method of claim 16, wherein said step of creating the ladder comprises determining the ladder output and providing data for the loyalty ladder.

18. The method of claim 16, wherein said step of performing scenario analysis comprises creating scenarios, viewing scenario impact, and saving scenarios.

19. An apparatus for analyzing marketing functions, comprising:
a machine executable medium, said medium including:
machine executable code for implementing a domain strategy process that identifies at least one brand opportunity in a domain; and
machine executable code for implementing a brand equity process that provides a plan to reach a target equity level for said at least one brand opportunity in said domain.

20. The apparatus of claim 19, wherein said machine executable medium further includes:
machine executable code that sets criteria for at least one imperative; and
machine executable code that sets criteria for at least one initiative, wherein said at least one initiative implements said at least one imperative.

21. The apparatus of claim 20, wherein said machine executable medium further includes:
machine executable code embodied in said medium for tracking performance of the at least one imperative and the at least one initiative using said at least one metric.
